SEQUENCE LISTING (358 sequences)

SEQ ID NO: 1 - DNA, 220 bp, Artificial Sequence
  Description of Artificial Sequence Synthetic polynucleotide
nnnnnnnnnncntantcggtctaagggtacngntacctccttttgaaggagctccagatgaaagactctgcctcttacctctgtgctgtgagagatancaacnatcacttaatcttgggcgctgggagcagactaattataatgccagatatccacaaccctgaccctgccgcgtaccagctgaaagactatgaacaggatggggaggcagnagnagnag

SEQ ID NO: 2 - DNA, 180 bp, Artificial Sequence
  Description of Artificial Sequence Synthetic polynucleotide
nnnnnnnnnngnangnncagggttctggatatttggtttnacaattagcttggtccctgctccaaagattaatttgtagttgctatccctcacagcacagaggtaagaggaagagtatttcttctggagctccttcaacaggaggaaactgtaccctttatacctactaaggaatgaaga

SEQ ID NO: 3 - DNA, 212 bp, Artificial Sequence
  Description of Artificial Sequence Synthetic polynucleotide
nnnnnnnnnnnntnncggttctcttnntcgctgctcatcctccaggtgcgggaggcagatgctgctgtttactactgtgctgtgnannanggcanngacaacaacctcntctttggtggaggnaccctactnntggttatnccnaatanccanaaccctgaccctgccgagnagcagcanaaaaactnnnaggggggtggagaagnannnnn

SEQ ID NO: 4 - DNA, 257 bp, Artificial Sequence
  Description of Artificial Sequence Synthetic polynucleotide
nnnnnnnnnnnnnnggnnnggnagctatggctttgaagctgaatttaacaagagccaaacctccttccacctgaagaaaccatctgcccttgtgagcgactccgctttgtacttctgtgctgtgagagacatcaacgctgccggcaacaacctaacttttggaggaagaaccatggtgctagttaaaccaaatatccataaccctgacgctgccgtgtaccagctgaaagactctgagggggctggagaggnaggng

SEQ ID NO: 5 - DNA, 236 bp, Artificial Sequence
  Description of Artificial Sequence Synthetic polynucleotide
nnnnnannggnnnnngtttatccctgccgacagaaagtccagcactctgagcctgccccgggtttccctgagcgacactgctgtgtactactgcctcgtgggtgaccggtctggaaacagcgatgaaattttcatcttaggaagaagaacgcttctagtcatccancccaacatccacaaccctgccgcggagnagcaccagaaaaaagatgatgagggggangnagnagnannnn

SEQ ID NO: 6 - DNA, 241 bp, Artificial Sequence
  Description of Artificial Sequence Synthetic polynucleotide
nnnnnnnnnnnnnnnntcnctgntctattgaataaaaaggataaacatctgtctctgcgcattgcagacacccagactggggactcagctatctacttctgtgcagagagccccggtggcggcagcaacttcttctttggtggaggagcantactactagtcgttctacatanccacaaccatgatnccgccgagtacntgctgaaaaaatatgatgaggatggagaagaagnagcatnan

SEQ ID NO: 7 - DNA, 237 bp, Artificial Sequence
  Description of Artificial Sequence Synthetic polynucleotide
nnnnnnnnctgagggtanncgtctctcgggagaagaaggaatcctttcctctcactgtgacatcggcccaaaagaacccgacagctttctatctctgtgccagtagtatgggggggggggcctacaatgagnacggcggcgggggagggacnntgctcgtcgtggaggaggacatgaaggtcttgcccgcnncngaggaagntgnanangaaccataaaaatgcgctggctgaannn

SEQ ID NO: 8 - DNA, 280 bp, Artificial Sequence
  Description of Artificial Sequence Synthetic polynucleotide
nnnnnnnnnnngctcnnnnnncncatacgagcaaggcgtcgagaaggacaagtttctcacaaccatgcaagcctgaccttgtccactctgacagtgaccagtgcccatcctgaagacagcagcttctacatctgcagtgctagagggggggggggggacgactactactacttcggcggggggggcatgctgatcgtggaggaggaggacatgnagctcctccccgccgccgaggttgttgtgtntnnancatcatactgntggtggagnagnagnagcn

SEQ ID NO: 9 - DNA, 172 bp, Artificial Sequence
  Description of Artificial Sequence Synthetic polynucleotide
nnnnnnnnnnnnnnngnnnnnnnnnnntactttcngaatgaagaacttattcagaaagcagaaataatcaatgagcgatttttagcccaatgctccaaaaactcatcctgtaccttggagttccagtccacggagtcaggggacacagcactgtatttctgtgccagcagca

SEQ ID NO: 10 - DNA, 278 bp, Artificial Sequence
  Description of Artificial Sequence Synthetic polynucleotide
nnngnnnnnnnanngganangcacaagaagcgattctcatctcaatgccccaagaacgcaccctgcagcctggcaatcctgtcctcagaaccgggagacacggcactgtatctctgcgccagcagtcaatcgggggggggggggagggccgtccgcagcggggggggggggggccgggggacggtcccaaagagaaagaaaacctgccccccgcgctcgggcggtgtgattgagcgaaacagacaggaaggnaagnaaaaaannnnancnncnctcnn

SEQ ID NO: 11 - DNA, 253 bp, Artificial Sequence
  Description of Artificial Sequence Synthetic polynucleotide
nnnnnnnngnnannntctgatgganacagtgtctctcgacaggcacaggctaaattctccctgtccctagagtctgccatccccaaccagacagctctttacttctgtgccaccagtgangcggggggcggggaccactacttcgggggggggaggcggaccagggtgctggtcgacgagaaaaaggagctcccccccgccgccgctgtggttgttgcttcataataatcaggnnggngaggnagnagnaann

SEQ ID NO: 12 - DNA, 20 bp, Artificial Sequence
  Description of Artificial Sequence Synthetic primer
tgcacgtaccagacatctgg

SEQ ID NO: 13 - DNA, 20 bp, Artificial Sequence
  Description of Artificial Sequence Synthetic primer
aggtcgtttttcttcattcc

SEQ ID NO: 14 - DNA, 39 bp, Artificial Sequence
  Description of Artificial Sequence Synthetic primer
gcctccctcgcgccatcagaggtcgtttttcttcattcc

SEQ ID NO: 15 - DNA, 20 bp, Artificial Sequence
  Description of Artificial Sequence Synthetic primer
tctgtaatcactctgtgtcc

SEQ ID NO: 16 - DNA, 20 bp, Artificial Sequence
  Description of Artificial Sequence Synthetic primer
agggacgatacaacatgacc

SEQ ID NO: 17 - DNA, 39 bp, Artificial Sequence
  Description of Artificial Sequence Synthetic primer
gcctccctcgcgccatcagagggacgatacaacatgacc

SEQ ID NO: 18 - DNA, 20 bp, Artificial Sequence
  Description of Artificial Sequence Synthetic primer
ctattcagtctctggaaacc

SEQ ID NO: 19 - DNA, 20 bp, Artificial Sequence
  Description of Artificial Sequence Synthetic primer
atacatcacaggggataacc

SEQ ID NO: 20 - DNA, 39 bp, Artificial Sequence
  Description of Artificial Sequence Synthetic primer
gcctccctcgcgccatcagatacatcacaggggataacc

SEQ ID NO: 21 - DNA, 20 bp, Artificial Sequence
  Description of Artificial Sequence Synthetic primer
tgtagccacaacaacattgc

SEQ ID NO: 22 - DNA, 20 bp, Artificial Sequence
  Description of Artificial Sequence Synthetic primer
aaagttacaaacgaagtggc

SEQ ID NO: 23 - DNA, 39 bp, Artificial Sequence
  Description of Artificial Sequence Synthetic primer
gcctccctcgcgccatcagaaagttacaaacgaagtggc

SEQ ID NO: 24 - DNA, 20 bp, Artificial Sequence
  Description of Artificial Sequence Synthetic primer
gcacttacacagacagctcc

SEQ ID NO: 25 - DNA, 20 bp, Artificial Sequence
  Description of Artificial Sequence Synthetic primer
tatggacatgaaacaagacc

SEQ ID NO: 26 - DNA, 39 bp, Artificial Sequence
  Description of Artificial Sequence Synthetic primer
gcctccctcgcgccatcagtatggacatgaaacaagacc

SEQ ID NO: 27 - DNA, 20 bp, Artificial Sequence
  Description of Artificial Sequence Synthetic primer
gcaactatacaaactattcc

SEQ ID NO: 28 - DNA, 20 bp, Artificial Sequence
  Description of Artificial Sequence Synthetic primer
gttttcttgctactcatacg

SEQ ID NO: 29 - DNA, 39 bp, Artificial Sequence
  Description of Artificial Sequence Synthetic primer
gcctccctcgcgccatcaggttttcttgctactcatacg

SEQ ID NO: 30 - DNA, 20 bp, Artificial Sequence
  Description of Artificial Sequence Synthetic primer
tgcacgtactctgtcagtcg

SEQ ID NO: 31 - DNA, 20 bp, Artificial Sequence
  Description of Artificial Sequence Synthetic primer
ggatatgagaagcagaaagg

SEQ ID NO: 32 - DNA, 39 bp, Artificial Sequence
  Description of Artificial Sequence Synthetic primer
gcctccctcgcgccatcagggatatgagaagcagaaagg

SEQ ID NO: 33 - DNA, 20 bp, Artificial Sequence
  Description of Artificial Sequence Synthetic primer
aatctcttctggtatgtsca

SEQ ID NO: 34 - DNA, 19 bp, Artificial Sequence
  Description of Artificial Sequence Synthetic primer
ggytttgaggctgaattta

SEQ ID NO: 35 - DNA, 38 bp, Artificial Sequence
  Description of Artificial Sequence Synthetic primer
gcctccctcgcgccatcagggytttgaggctgaattta

SEQ ID NO: 36 - DNA, 20 bp, Artificial Sequence
  Description of Artificial Sequence Synthetic primer
gtccaatatcctggagaagg

SEQ ID NO: 37 - DNA, 20 bp, Artificial Sequence
  Description of Artificial Sequence Synthetic primer
aaccacttctttccacttgg

SEQ ID NO: 38 - DNA, 39 bp, Artificial Sequence
  Description of Artificial Sequence Synthetic primer
gcctccctcgcgccatcagaaccacttctttccacttgg

SEQ ID NO: 39 - DNA, 20 bp, Artificial Sequence
  Description of Artificial Sequence Synthetic primer
aatgcaattatacagtgagc

SEQ ID NO: 40 - DNA, 20 bp, Artificial Sequence
  Description of Artificial Sequence Synthetic primer
tgagaacacaaagtcgaacg

SEQ ID NO: 41 - DNA, 39 bp, Artificial Sequence
  Description of Artificial Sequence Synthetic primer
gcctccctcgcgccatcagtgagaacacaaagtcgaacg

SEQ ID NO: 42 - DNA, 20 bp, Artificial Sequence
  Description of Artificial Sequence Synthetic primer
tcttaattgtacttatcagg

SEQ ID NO: 43 - DNA, 20 bp, Artificial Sequence
  Description of Artificial Sequence Synthetic primer
tcaatcaagccagaaggagc

SEQ ID NO: 44 - DNA, 39 bp, Artificial Sequence
  Description of Artificial Sequence Synthetic primer
gcctccctcgcgccatcagtcaatcaagccagaaggagc

SEQ ID NO: 45 - DNA, 20 bp, Artificial Sequence
  Description of Artificial Sequence Synthetic primer
tcagtgttccagagggagcc

SEQ ID NO: 46 - DNA, 20 bp, Artificial Sequence
  Description of Artificial Sequence Synthetic primer
atggaaggtttacagcacag

SEQ ID NO: 47 - DNA, 39 bp, Artificial Sequence
  Description of Artificial Sequence Synthetic primer
gcctccctcgcgccatcagatggaaggtttacagcacag

SEQ ID NO: 48 - DNA, 20 bp, Artificial Sequence
  Description of Artificial Sequence Synthetic primer
accctgagtgtccaggaggg

SEQ ID NO: 49 - DNA, 20 bp, Artificial Sequence
  Description of Artificial Sequence Synthetic primer
ttatagacattcgttcaaat

SEQ ID NO: 50 - DNA, 39 bp, Artificial Sequence
  Description of Artificial Sequence Synthetic primer
gcctccctcgcgccatcagttatagacattcgttcaaat

SEQ ID NO: 51 - DNA, 20 bp, Artificial Sequence
  Description of Artificial Sequence Synthetic primer
tggactgcacatatgacacc

SEQ ID NO: 52 - DNA, 20 bp, Artificial Sequence
  Description of Artificial Sequence Synthetic primer
cagcaaaatgcaacagaagg

SEQ ID NO: 53 - DNA, 39 bp, Artificial Sequence
  Description of Artificial Sequence Synthetic primer
gcctccctcgcgccatcagcagcaaaatgcaacagaagg

SEQ ID NO: 54 - DNA, 20 bp, Artificial Sequence
  Description of Artificial Sequence Synthetic primer
agctgaagtgcaactattcc

SEQ ID NO: 55 - DNA, 20 bp, Artificial Sequence
  Description of Artificial Sequence Synthetic primer
tctagagagagcatcaaagg

SEQ ID NO: 56 - DNA, 39 bp, Artificial Sequence
  Description of Artificial Sequence Synthetic primer
gcctccctcgcgccatcagtctagagagagcatcaaagg

SEQ ID NO: 57 - DNA, 20 bp, Artificial Sequence
  Description of Artificial Sequence Synthetic primer
aatgccaccatgaactgcag

SEQ ID NO: 58 - DNA, 20 bp, Artificial Sequence
  Description of Artificial Sequence Synthetic primer
gaaagagagaaacacagtgg

SEQ ID NO: 59 - DNA, 39 bp, Artificial Sequence
  Description of Artificial Sequence Synthetic primer
gcctccctcgcgccatcaggaaagagagaaacacagtgg

SEQ ID NO: 60 - DNA, 20 bp, Artificial Sequence
  Description of Artificial Sequence Synthetic primer
gctctgacattaaactgcac

SEQ ID NO: 61 - DNA, 20 bp, Artificial Sequence
  Description of Artificial Sequence Synthetic primer
caggagacggacagcagagg

SEQ ID NO: 62 - DNA, 39 bp, Artificial Sequence
  Description of Artificial Sequence Synthetic primer
gcctccctcgcgccatcagcaggagacggacagcagagg

SEQ ID NO: 63 - DNA, 20 bp, Artificial Sequence
  Description of Artificial Sequence Synthetic primer
atgtgaccttggactgtgtg

SEQ ID NO: 64 - DNA, 20 bp, Artificial Sequence
  Description of Artificial Sequence Synthetic primer
gagcaaaatgaaataagtgg

SEQ ID NO: 65 - DNA, 39 bp, Artificial Sequence
  Description of Artificial Sequence Synthetic primer
gcctccctcgcgccatcaggagcaaaatgaaataagtgg

SEQ ID NO: 66 - DNA, 20 bp, Artificial Sequence
  Description of Artificial Sequence Synthetic primer
actgcagttacacagtcagc

SEQ ID NO: 67 - DNA, 20 bp, Artificial Sequence
  Description of Artificial Sequence Synthetic primer
agaaagaaaggctaaaagcc

SEQ ID NO: 68 - DNA, 39 bp, Artificial Sequence
  Description of Artificial Sequence Synthetic primer
gcctccctcgcgccatcagagaaagaaaggctaaaagcc

SEQ ID NO: 69 - DNA, 20 bp, Artificial Sequence
  Description of Artificial Sequence Synthetic primer
actgcagtttcactgatagc

SEQ ID NO: 70 - DNA, 20 bp, Artificial Sequence
  Description of Artificial Sequence Synthetic primer
caagtggaagacttaatgcc

SEQ ID NO: 71 - DNA, 39 bp, Artificial Sequence
  Description of Artificial Sequence Synthetic primer
gcctccctcgcgccatcagcaagtggaagacttaatgcc

SEQ ID NO: 72 - DNA, 20 bp, Artificial Sequence
  Description of Artificial Sequence Synthetic primer
gggagccaattccacgctgc

SEQ ID NO: 73 - DNA, 20 bp, Artificial Sequence
  Description of Artificial Sequence Synthetic primer
atggaagattaagcgccacg

SEQ ID NO: 74 - DNA, 39 bp, Artificial Sequence
  Description of Artificial Sequence Synthetic primer
gcctccctcgcgccatcagatggaagattaagcgccacg

SEQ ID NO: 75 - DNA, 20 bp, Artificial Sequence
  Description of Artificial Sequence Synthetic primer
atttcaattataaactgtgc

SEQ ID NO: 76 - DNA, 20 bp, Artificial Sequence
  Description of Artificial Sequence Synthetic primer
aaggaagattcacaatctcc

SEQ ID NO: 77 - DNA, 39 bp, Artificial Sequence
  Description of Artificial Sequence Synthetic primer
gcctccctcgcgccatcagaaggaagattcacaatctcc

SEQ ID NO: 78 - DNA, 20 bp, Artificial Sequence
  Description of Artificial Sequence Synthetic primer
gcaccaatttcacctgcagc

SEQ ID NO: 79 - DNA, 20 bp, Artificial Sequence
  Description of Artificial Sequence Synthetic primer
aggacgaataagtgccactc

SEQ ID NO: 80 - DNA, 39 bp, Artificial Sequence
  Description of Artificial Sequence Synthetic primer
gcctccctcgcgccatcagaggacgaataagtgccactc

SEQ ID NO: 81 - DNA, 20 bp, Artificial Sequence
  Description of Artificial Sequence Synthetic primer
tcaccacgtactgcaattcc

SEQ ID NO: 82 - DNA, 20 bp, Artificial Sequence
  Description of Artificial Sequence Synthetic primer
agactgacatttcagtttgg

SEQ ID NO: 83 - DNA, 39 bp, Artificial Sequence
  Description of Artificial Sequence Synthetic primer
gcctccctcgcgccatcagagactgacatttcagtttgg

SEQ ID NO: 84 - DNA, 20 bp, Artificial Sequence
  Description of Artificial Sequence Synthetic primer
tcgacagattcmctcccagg

SEQ ID NO: 85 - DNA, 20 bp, Artificial Sequence
  Description of Artificial Sequence Synthetic primer
gtccagyaccttgatcctgc

SEQ ID NO: 86 - DNA, 39 bp, Artificial Sequence
  Description of Artificial Sequence Synthetic primer
gcctccctcgcgccatcaggtccagyaccttgatcctgc

SEQ ID NO: 87 - DNA, 20 bp, Artificial Sequence
  Description of Artificial Sequence Synthetic primer
cctcaagtgttttttccagc

SEQ ID NO: 88 - DNA, 20 bp, Artificial Sequence
  Description of Artificial Sequence Synthetic primer
gtgacagtagttacgggtgg

SEQ ID NO: 89 - DNA, 39 bp, Artificial Sequence
  Description of Artificial Sequence Synthetic primer
gcctccctcgcgccatcaggtgacagtagttacgggtgg

SEQ ID NO: 90 - DNA, 20 bp, Artificial Sequence
  Description of Artificial Sequence Synthetic primer
cagcatgtttgattatttcc

SEQ ID NO: 91 - DNA, 20 bp, Artificial Sequence
  Description of Artificial Sequence Synthetic primer
atctataagttccattaagg

SEQ ID NO: 92 - DNA, 39 bp, Artificial Sequence
  Description of Artificial Sequence Synthetic primer
gcctccctcgcgccatcagatctataagttccattaagg

SEQ ID NO: 93 - DNA, 20 bp, Artificial Sequence
  Description of Artificial Sequence Synthetic primer
ctccaaggctttatattctg

SEQ ID NO: 94 - DNA, 20 bp, Artificial Sequence
  Description of Artificial Sequence Synthetic primer
atgatattactgaagggtgg

SEQ ID NO: 95 - DNA, 39 bp, Artificial Sequence
  Description of Artificial Sequence Synthetic primer
gcctccctcgcgccatcagatgatattactgaagggtgg

SEQ ID NO: 96 - DNA, 20 bp, Artificial Sequence
  Description of Artificial Sequence Synthetic primer
actgcacgtcatcaaagacg

SEQ ID NO: 97 - DNA, 20 bp, Artificial Sequence
  Description of Artificial Sequence Synthetic primer
ttgatgatgctacagaaagg

SEQ ID NO: 98 - DNA, 39 bp, Artificial Sequence
  Description of Artificial Sequence Synthetic primer
gcctccctcgcgccatcagttgatgatgctacagaaagg

SEQ ID NO: 99 - DNA, 20 bp, Artificial Sequence
  Description of Artificial Sequence Synthetic primer
tgaactgcacttcttcaagc

SEQ ID NO: 100 - DNA, 20 bp, Artificial Sequence
  Description of Artificial Sequence Synthetic primer
cttgatagccttatataagg

SEQ ID NO: 101 - DNA, 39 bp, Artificial Sequence
  Description of Artificial Sequence Synthetic primer
gcctccctcgcgccatcagcttgatagccttatataagg

SEQ ID NO: 102 - DNA, 20 bp, Artificial Sequence
  Description of Artificial Sequence Synthetic primer
tcaattgcagttatgaagtg

SEQ ID NO: 103 - DNA, 20 bp, Artificial Sequence
  Description of Artificial Sequence Synthetic primer
tttatgctaacttcaagtgg

SEQ ID NO: 104 - DNA, 39 bp, Artificial Sequence
  Description of Artificial Sequence Synthetic primer
gcctccctcgcgccatcagtttatgctaacttcaagtgg

SEQ ID NO: 105 - DNA, 20 bp, Artificial Sequence
  Description of Artificial Sequence Synthetic primer
gcacatatgacaccagtgag

SEQ ID NO: 106 - DNA, 20 bp, Artificial Sequence
  Description of Artificial Sequence Synthetic primer
tcgccaagaagcttataagc

SEQ ID NO: 107 - DNA, 39 bp, Artificial Sequence
  Description of Artificial Sequence Synthetic primer
gcctccctcgcgccatcagtcgccaagaagcttataagc

SEQ ID NO: 108 - DNA, 20 bp, Artificial Sequence
  Description of Artificial Sequence Synthetic primer
tctactgcaattattcaacc

SEQ ID NO: 109 - DNA, 20 bp, Artificial Sequence
  Description of Artificial Sequence Synthetic primer
caggagggacgattaatggc

SEQ ID NO: 110 - DNA, 39 bp, Artificial Sequence
  Description of Artificial Sequence Synthetic primer
gcctccctcgcgccatcagcaggagggacgattaatggc

SEQ ID NO: 111 - DNA, 20 bp, Artificial Sequence
  Description of Artificial Sequence Synthetic primer
tgaactgcacatacacatcc

SEQ ID NO: 112 - DNA, 20 bp, Artificial Sequence
  Description of Artificial Sequence Synthetic primer
acagcaaaaacttcggaggc

SEQ ID NO: 113 - DNA, 39 bp, Artificial Sequence
  Description of Artificial Sequence Synthetic primer
gcctccctcgcgccatcagacagcaaaaacttcggaggc

SEQ ID NO: 114 - DNA, 20 bp, Artificial Sequence
  Description of Artificial Sequence Synthetic primer
aactgcagttactcggtagg

SEQ ID NO: 115 - DNA, 20 bp, Artificial Sequence
  Description of Artificial Sequence Synthetic primer
aagcatggaagattaattgc

SEQ ID NO: 116 - DNA, 39 bp, Artificial Sequence
  Description of Artificial Sequence Synthetic primer
gcctccctcgcgccatcagaagcatggaagattaattgc

SEQ ID NO: 117 - DNA, 20 bp, Artificial Sequence
  Description of Artificial Sequence Synthetic primer
gcagacagacttgtcactgg

SEQ ID NO: 118 - DNA, 20 bp, Artificial Sequence
  Description of Artificial Sequence Synthetic primer
agtctctcagctggtacacg

SEQ ID NO: 119 - DNA, 39 bp, Artificial Sequence
  Description of Artificial Sequence Synthetic primer
gccttgccagcccgctcagagtctctcagctggtacacg

SEQ ID NO: 120 - DNA, 20 bp, Artificial Sequence
  Description of Artificial Sequence Synthetic primer
aatgaaacgtgagcatctgg

SEQ ID NO: 121 - DNA, 20 bp, Artificial Sequence
  Description of Artificial Sequence Synthetic primer
cattgaaaacaagactgtgc

SEQ ID NO: 122 - DNA, 39 bp, Artificial Sequence
  Description of Artificial Sequence Synthetic primer
gcctccctcgcgccatcagcattgaaaacaagactgtgc

SEQ ID NO: 123 - DNA, 20 bp, Artificial Sequence
  Description of Artificial Sequence Synthetic primer
gtgtccccatctctaatcac

SEQ ID NO: 124 - DNA, 20 bp, Artificial Sequence
  Description of Artificial Sequence Synthetic primer
tgaaatctcagagaagtctg

SEQ ID NO: 125 - DNA, 39 bp, Artificial Sequence
  Description of Artificial Sequence Synthetic primer
gcctccctcgcgccatcagtgaaatctcagagaagtctg

SEQ ID NO: 126 - DNA, 20 bp, Artificial Sequence
  Description of Artificial Sequence Synthetic primer
tatgtattggtataaacagg

SEQ ID NO: 127 - DNA, 20 bp, Artificial Sequence
  Description of Artificial Sequence Synthetic primer
ctctaagaaatttctgaaga

SEQ ID NO: 128 - DNA, 39 bp, Artificial Sequence
  Description of Artificial Sequence Synthetic primer
gcctccctcgcgccatcagctctaagaaatttctgaaga

SEQ ID NO: 129 - DNA, 20 bp, Artificial Sequence
  Description of Artificial Sequence Synthetic primer
gtctttgaaatgtgaacaac

SEQ ID NO: 130 - DNA, 20 bp, Artificial Sequence
  Description of Artificial Sequence Synthetic primer
ggagctcatgtttgtctaca

SEQ ID NO: 131 - DNA, 39 bp, Artificial Sequence
  Description of Artificial Sequence Synthetic primer
gcctccctcgcgccatcagggagctcatgtttgtctaca

SEQ ID NO: 132 - DNA, 20 bp, Artificial Sequence
  Description of Artificial Sequence Synthetic primer
gatcaaaacgagaggacagc

SEQ ID NO: 133 - DNA, 20 bp, Artificial Sequence
  Description of Artificial Sequence Synthetic primer
caggggccccagtttatctt

SEQ ID NO: 134 - DNA, 39 bp, Artificial Sequence
  Description of Artificial Sequence Synthetic primer
gcctccctcgcgccatcagcaggggccccagtttatctt

SEQ ID NO: 135 - DNA, 20 bp, Artificial Sequence
  Description of Artificial Sequence Synthetic primer
gaaacaraggaaacttccct

SEQ ID NO: 136 - DNA, 39 bp, Artificial Sequence
  Description of Artificial Sequence Synthetic primer
gcctccctcgcgccatcaggaaacaraggaaacttccct

SEQ ID NO: 137 - DNA, 20 bp, Artificial Sequence
  Description of Artificial Sequence Synthetic primer
gtgtgcccaggatatgaacc

SEQ ID NO: 138 - DNA, 20 bp, Artificial Sequence
  Description of Artificial Sequence Synthetic primer
caggatatgagacataatgc

SEQ ID NO: 139 - DNA, 20 bp, Artificial Sequence
  Description of Artificial Sequence Synthetic primer
ggtatcgacaagacccaggc

SEQ ID NO: 140 - DNA, 39 bp, Artificial Sequence
  Description of Artificial Sequence Synthetic primer
gcctccctcgcgccatcagggtatcgacaagacccaggc

SEQ ID NO: 141 - DNA, 20 bp, Artificial Sequence
  Description of Artificial Sequence Synthetic primer
tagacaagatctaggactgg

SEQ ID NO: 142 - DNA, 39 bp, Artificial Sequence
  Description of Artificial Sequence Synthetic primer
gcctccctcgcgccatcagtagacaagatctaggactgg

SEQ ID NO: 143 - DNA, 20 bp, Artificial Sequence
  Description of Artificial Sequence Synthetic primer
ctcaggtgtgatccaatttc

SEQ ID NO: 144 - DNA, 20 bp, Artificial Sequence
  Description of Artificial Sequence Synthetic primer
tctaatttacttccaaggca

SEQ ID NO: 145 - DNA, 39 bp, Artificial Sequence
  Description of Artificial Sequence Synthetic primer
gcctccctcgcgccatcagtctaatttacttccaaggca

SEQ ID NO: 146 - DNA, 20 bp, Artificial Sequence
  Description of Artificial Sequence Synthetic primer
tcccagagtgatgctcaacg

SEQ ID NO: 147 - DNA, 39 bp, Artificial Sequence
  Description of Artificial Sequence Synthetic primer
gcctccctcgcgccatcagtcccagagtgatgctcaacg

SEQ ID NO: 148 - DNA, 20 bp, Artificial Sequence
  Description of Artificial Sequence Synthetic primer
acttacttcaattatgaagc

SEQ ID NO: 149 - DNA, 39 bp, Artificial Sequence
  Description of Artificial Sequence Synthetic primer
gcctccctcgcgccatcagacttacttcaattatgaagc

SEQ ID NO: 150 - DNA, 20 bp, Artificial Sequence
  Description of Artificial Sequence Synthetic primer
ccagaatgaagctcaactag

SEQ ID NO: 151 - DNA, 39 bp, Artificial Sequence
  Description of Artificial Sequence Synthetic primer
gcctccctcgcgccatcagccagaatgaagctcaactag

SEQ ID NO: 152 - DNA, 20 bp, Artificial Sequence
  Description of Artificial Sequence Synthetic primer
gagacctctctgtgtactgg

SEQ ID NO: 153 - DNA, 20 bp, Artificial Sequence
  Description of Artificial Sequence Synthetic primer
ctcattcagtattataatgg

SEQ ID NO: 154 - DNA, 39 bp, Artificial Sequence
  Description of Artificial Sequence Synthetic primer
gcctccctcgcgccatcagctcattcagtattataatgg

SEQ ID NO: 155 - DNA, 20 bp, Artificial Sequence
  Description of Artificial Sequence Synthetic primer
ggaatcacccagagcccaag

SEQ ID NO: 156 - DNA, 20 bp, Artificial Sequence
  Description of Artificial Sequence Synthetic primer
gacatgggctgaggctgatc

SEQ ID NO: 157 - DNA, 39 bp, Artificial Sequence
  Description of Artificial Sequence Synthetic primer
gcctccctcgcgccatcaggacatgggctgaggctgatc

SEQ ID NO: 158 - DNA, 20 bp, Artificial Sequence
  Description of Artificial Sequence Synthetic primer
cctaaggatcgattttctgc

SEQ ID NO: 159 - DNA, 20 bp, Artificial Sequence
  Description of Artificial Sequence Synthetic primer
actctcaagatccagcctgc

SEQ ID NO: 160 - DNA, 39 bp, Artificial Sequence
  Description of Artificial Sequence Synthetic primer
gcctccctcgcgccatcagactctcaagatccagcctgc

SEQ ID NO: 161 - DNA, 20 bp, Artificial Sequence
  Description of Artificial Sequence Synthetic primer
aggtgacagagatgggacaa

SEQ ID NO: 162 - DNA, 20 bp, Artificial Sequence
  Description of Artificial Sequence Synthetic primer
tgcagggactggaattgctg

SEQ ID NO: 163 - DNA, 39 bp, Artificial Sequence
  Description of Artificial Sequence Synthetic primer
gcctccctcgcgccatcagtgcagggactggaattgctg

SEQ ID NO: 164 - DNA, 20 bp, Artificial Sequence
  Description of Artificial Sequence Synthetic primer
gtacagacagaccatgatgc

SEQ ID NO: 165 - DNA, 39 bp, Artificial Sequence
  Description of Artificial Sequence Synthetic primer
gcctccctcgcgccatcaggtacagacagaccatgatgc

SEQ ID NO: 166 - DNA, 20 bp, Artificial Sequence
  Description of Artificial Sequence Synthetic primer
ctatcctatccctagacacg

SEQ ID NO: 167 - DNA, 20 bp, Artificial Sequence
  Description of Artificial Sequence Synthetic primer
aagatgcagagcgataaagg

SEQ ID NO: 168 - DNA, 39 bp, Artificial Sequence
  Description of Artificial Sequence Synthetic primer
gcctccctcgcgccatcagaagatgcagagcgataaagg

SEQ ID NO: 169 - DNA, 20 bp, Artificial Sequence
  Description of Artificial Sequence Synthetic primer
agatgtgacccaatttctgg

SEQ ID NO: 170 - DNA, 20 bp, Artificial Sequence
  Description of Artificial Sequence Synthetic primer
agtctaaacaggatgagtcc

SEQ ID NO: 171 - DNA, 39 bp, Artificial Sequence
  Description of Artificial Sequence Synthetic primer
gcctccctcgcgccatcagagtctaaacaggatgagtcc

SEQ ID NO: 172 - DNA, 20 bp, Artificial Sequence
  Description of Artificial Sequence Synthetic primer
tcagactttgaaccataacg

SEQ ID NO: 173 - DNA, 20 bp, Artificial Sequence
  Description of Artificial Sequence Synthetic primer
aaagattttaacaatgaagc

SEQ ID NO: 174 - DNA, 39 bp, Artificial Sequence
  Description of Artificial Sequence Synthetic primer
gcctccctcgcgccatcagaaagattttaacaatgaagc

SEQ ID NO: 175 - DNA, 20 bp, Artificial Sequence
  Description of Artificial Sequence Synthetic primer
tattgtgccccaataaaagg

SEQ ID NO: 176 - DNA, 20 bp, Artificial Sequence
  Description of Artificial Sequence Synthetic primer
aatgtctttgatgaaacagg

SEQ ID NO: 177 - DNA, 39 bp, Artificial Sequence
  Description of Artificial Sequence Synthetic primer
gcctccctcgcgccatcagaatgtctttgatgaaacagg

SEQ ID NO: 178 - DNA, 20 bp, Artificial Sequence
  Description of Artificial Sequence Synthetic primer
atccatcttctggtcacatg

SEQ ID NO: 179 - DNA, 20 bp, Artificial Sequence
  Description of Artificial Sequence Synthetic primer
aacattgcagttgattcagg

SEQ ID NO: 180 - DNA, 39 bp, Artificial Sequence
  Description of Artificial Sequence Synthetic primer
gcctccctcgcgccatcagaacattgcagttgattcagg

SEQ ID NO: 181 - DNA, 20 bp, Artificial Sequence
  Description of Artificial Sequence Synthetic primer
gcagcccaatgaaaggacac

SEQ ID NO: 182 - DNA, 20 bp, Artificial Sequence
  Description of Artificial Sequence Synthetic primer
aatatcatagatgagtcagg

SEQ ID NO: 183 - DNA, 39 bp, Artificial Sequence
  Description of Artificial Sequence Synthetic primer
gcctccctcgcgccatcagaatatcatagatgagtcagg

SEQ ID NO: 184 - DNA, 20 bp, Artificial Sequence
  Description of Artificial Sequence Synthetic primer
tgaacagaatttgaaccacg

SEQ ID NO: 185 - DNA, 20 bp, Artificial Sequence
  Description of Artificial Sequence Synthetic primer
tttcagaaaggagatatagc

SEQ ID NO: 186 - DNA, 39 bp, Artificial Sequence
  Description of Artificial Sequence Synthetic primer
gcctccctcgcgccatcagtttcagaaaggagatatagc

SEQ ID NO: 187 - DNA, 20 bp, Artificial Sequence
  Description of Artificial Sequence Synthetic primer
tcgagtgccgttccctggac

SEQ ID NO: 188 - DNA, 20 bp, Artificial Sequence
  Description of Artificial Sequence Synthetic primer
gatggcaacttccaatgagg

SEQ ID NO: 189 - DNA, 39 bp, Artificial Sequence
  Description of Artificial Sequence Synthetic primer
gcctccctcgcgccatcaggatggcaacttccaatgagg

SEQ ID NO: 190 - DNA, 20 bp, Artificial Sequence
  Description of Artificial Sequence Synthetic primer
gcaaagatggattgtgttcc

SEQ ID NO: 191 - DNA, 20 bp, Artificial Sequence
  Description of Artificial Sequence Synthetic primer
cgctggaagaagagctcaag

SEQ ID NO: 192 - DNA, 39 bp, Artificial Sequence
  Description of Artificial Sequence Synthetic primer
gcctccctcgcgccatcagcgctggaagaagagctcaag

SEQ ID NO: 193 - DNA, 20 bp, Artificial Sequence
  Description of Artificial Sequence Synthetic primer
catttggtcaaaggaaaagg

SEQ ID NO: 194 - DNA, 20 bp, Artificial Sequence
  Description of Artificial Sequence Synthetic primer
gaatgaacaagttcttcaag

SEQ ID NO: 195 - DNA, 39 bp, Artificial Sequence
  Description of Artificial Sequence Synthetic primer
gcctccctcgcgccatcaggaatgaacaagttcttcaag

SEQ ID NO: 196 - DNA, 20 bp, Artificial Sequence
  Description of Artificial Sequence Synthetic primer
atgctggaatgttctcagac

SEQ ID NO: 197 - DNA, 20 bp, Artificial Sequence
  Description of Artificial Sequence Synthetic primer
gtcaaagatataaacaaagg

SEQ ID NO: 198 - DNA, 39 bp, Artificial Sequence
  Description of Artificial Sequence Synthetic primer
gcctccctcgcgccatcaggtcaaagatataaacaaagg

SEQ ID NO: 199 - DNA, 20 bp, Artificial Sequence
  Description of Artificial Sequence Synthetic primer
ctctggaatgttctcaaacc

SEQ ID NO: 200 - DNA, 20 bp, Artificial Sequence
  Description of Artificial Sequence Synthetic primer
taattccacagagaagggag

SEQ ID NO: 201 - DNA, 39 bp, Artificial Sequence
  Description of Artificial Sequence Synthetic primer
gcctccctcgcgccatcagtaattccacagagaagggag

SEQ ID NO: 202 - DNA, 20 bp, Artificial Sequence
  Description of Artificial Sequence Synthetic primer
cccagaatatgaatcatgtt

SEQ ID NO: 203 - DNA, 20 bp, Artificial Sequence
  Description of Artificial Sequence Synthetic primer
attcacctggcactgggagc

SEQ ID NO: 204 - DNA, 39 bp, Artificial Sequence
  Description of Artificial Sequence Synthetic primer
gcctccctcgcgccatcagattcacctggcactgggagc

SEQ ID NO: 205 - DNA, 20 bp, Artificial Sequence
  Description of Artificial Sequence Synthetic primer
ttgttctcagaatatgaacc

SEQ ID NO: 206 - DNA, 20 bp, Artificial Sequence
  Description of Artificial Sequence Synthetic primer
tgaggtgactgataagggag

SEQ ID NO: 207 - DNA, 39 bp, Artificial Sequence
  Description of Artificial Sequence Synthetic primer
gcctccctcgcgccatcagtgaggtgactgataagggag

SEQ ID NO: 208 - DNA, 20 bp, Artificial Sequence
  Description of Artificial Sequence Synthetic primer
atgtgtccaggatatggacc

SEQ ID NO: 209 - DNA, 20 bp, Artificial Sequence
  Description of Artificial Sequence Synthetic primer
aaaaggagatattcctgagg

SEQ ID NO: 210 - DNA, 39 bp, Artificial Sequence
  Description of Artificial Sequence Synthetic primer
gcctccctcgcgccatcagaaaaggagatattcctgagg

SEQ ID NO: 211 - DNA, 20 bp, Artificial Sequence
  Description of Artificial Sequence Synthetic primer
tcaccatgatgttctggtac

SEQ ID NO: 212 - DNA, 20 bp, Artificial Sequence
  Description of Artificial Sequence Synthetic primer
ctggacagagcctgacactg

SEQ ID NO: 213 - DNA, 39 bp, Artificial Sequence
  Description of Artificial Sequence Synthetic primer
gcctccctcgcgccatcagctggacagagcctgacactg

SEQ ID NO: 214 - DNA, 20 bp, Artificial Sequence
  Description of Artificial Sequence Synthetic primer
tgtggagggaacatcaaacc

SEQ ID NO: 215 - DNA, 20 bp, Artificial Sequence
  Description of Artificial Sequence Synthetic primer
ttctactccgttggtattgg

SEQ ID NO: 216 - DNA, 39 bp, Artificial Sequence
  Description of Artificial Sequence Synthetic primer
gcctccctcgcgccatcagttctactccgttggtattgg

SEQ ID NO: 217 - DNA, 20 bp, Artificial Sequence
  Description of Artificial Sequence Synthetic primer
gtgtggccttttgggtgtgg

SEQ ID NO: 218 - DNA, 20 bp, Artificial Sequence
  Description of Artificial Sequence Synthetic primer
tctgatggctcaaacacagc

SEQ ID NO: 219 - DNA, 39 bp, Artificial Sequence
  Description of Artificial Sequence Synthetic primer
gccttgccagcccgctcagtctgatggctcaaacacagc

SEQ ID NO: 220 - DNA, 20 bp, Artificial Sequence
  Description of Artificial Sequence Synthetic primer
tgtatgaaacaagttggtgg

SEQ ID NO: 221 - DNA, 20 bp, Artificial Sequence
  Description of Artificial Sequence Synthetic primer
cagaatgcaaaaagtggtcg

SEQ ID NO: 222 - DNA, 39 bp, Artificial Sequence
  Description of Artificial Sequence Synthetic primer
gcctccctcgcgccatcagcagaatgcaaaaagtggtcg

SEQ ID NO: 223 - DNA, 20 bp, Artificial Sequence
  Description of Artificial Sequence Synthetic primer
atgaaaggagaagcgatcgg

SEQ ID NO: 224 - DNA, 20 bp, Artificial Sequence
  Description of Artificial Sequence Synthetic primer
tggtttcaaagacaatttcc

SEQ ID NO: 225 - DNA, 39 bp, Artificial Sequence
  Description of Artificial Sequence Synthetic primer
gcctccctcgcgccatcagtggtttcaaagacaatttcc

SEQ ID NO: 226 - DNA, 20 bp, Artificial Sequence
  Description of Artificial Sequence Synthetic primer
gacactgtatattcaaatcc

SEQ ID NO: 227 - DNA, 20 bp, Artificial Sequence
  Description of Artificial Sequence Synthetic primer
gcagattttactcaaggacg

SEQ ID NO: 228 - DNA, 39 bp, Artificial Sequence
  Description of Artificial Sequence Synthetic primer
gcctccctcgcgccatcaggcagattttactcaaggacg

SEQ ID NO: 229 - DNA, 20 bp, Artificial Sequence
  Description of Artificial Sequence Synthetic primer
agacaagcgacatttgttcc

SEQ ID NO: 230 - DNA, 20 bp, Artificial Sequence
  Description of Artificial Sequence Synthetic primer
acggatggtttggtatgagg

SEQ ID NO: 231 - DNA, 39 bp, Artificial Sequence
  Description of Artificial Sequence Synthetic primer
gccttgccagcccgctcagacggatggtttggtatgagg

SEQ ID NO: 232 - DNA, 20 bp, Artificial Sequence
  Description of Artificial Sequence Synthetic primer
gggtcatctgctgaaatcac

SEQ ID NO: 233 - DNA, 20 bp, Artificial Sequence
  Description of Artificial Sequence Synthetic primer
aggaggggaaggccccacag

SEQ ID NO: 234 - DNA, 39 bp, Artificial Sequence
  Description of Artificial Sequence Synthetic primer
gcctccctcgcgccatcagaggaggggaaggccccacag

SEQ ID NO: 235 - DNA, 20 bp, Artificial Sequence
  Description of Artificial Sequence Synthetic primer
gggtcatcagctgtaatcac

SEQ ID NO: 236 - DNA, 20 bp, Artificial Sequence
  Description of Artificial Sequence Synthetic primer
aggaggggaagaccccacag

SEQ ID NO: 237 - DNA, 39 bp, Artificial Sequence
  Description of Artificial Sequence Synthetic primer
gcctccctcgcgccatcagaggaggggaagaccccacag

SEQ ID NO: 238 - DNA, 20 bp, Artificial Sequence
  Description of Artificial Sequence Synthetic primer
agcccgcctggaatgtgtgg

SEQ ID NO: 239 - DNA, 20 bp, Artificial Sequence
  Description of Artificial Sequence Synthetic primer
gcactgtcagaaaggaatcc

SEQ ID NO: 240 - DNA, 39 bp, Artificial Sequence
  Description of Artificial Sequence Synthetic primer
gcctccctcgcgccatcaggcactgtcagaaaggaatcc

SEQ ID NO: 241 - DNA, 20 bp, Artificial Sequence
  Description of Artificial Sequence Synthetic primer
aagaaaagtattgacatacc

SEQ ID NO: 242 - DNA, 20 bp, Artificial Sequence
  Description of Artificial Sequence Synthetic primer
atattgtctcaacaaaatcc

SEQ ID NO: 243 - DNA, 39 bp, Artificial Sequence
  Description of Artificial Sequence Synthetic primer
gcctccctcgcgccatcagatattgtctcaacaaaatcc

SEQ ID NO: 244 - DNA, 20 bp, Artificial Sequence
  Description of Artificial Sequence Synthetic primer
agagtgcccacatatcttgg

SEQ ID NO: 245 - DNA, 20 bp, Artificial Sequence
  Description of Artificial Sequence Synthetic primer
gctcaagattgctcaggtgg

SEQ ID NO: 246 - DNA, 39 bp, Artificial Sequence
  Description of Artificial Sequence Synthetic primer
gcctccctcgcgccatcaggctcaagattgctcaggtgg

SEQ ID NO: 247 - DNA, 20 bp, Artificial Sequence
  Description of Artificial Sequence Synthetic primer
ggatcccagaatcgtgttgc

SEQ ID NO: 248 - DNA, 20 bp, Artificial Sequence
  Description of Artificial Sequence Synthetic primer
ggtatgttccagccttctgg

SEQ ID NO: 249 - DNA, 39 bp, Artificial Sequence
  Description of Artificial Sequence Synthetic primer
gccttgccagcccgctcagggtatgttccagccttctgg

SEQ ID NO: 250 - DNA, 20 bp, Artificial Sequence
  Description of Artificial Sequence Synthetic primer
agtgaaggtctcctgcaagg

SEQ ID NO: 251 - DNA, 20 bp, Artificial Sequence
  Description of Artificial Sequence Synthetic primer
agtgaaggtttcctgcaagg

SEQ ID NO: 252 - DNA, 19 bp, Artificial Sequence
  Description of Artificial Sequence Synthetic primer
agttccagggcagagtcac

SEQ ID NO: 253 - DNA, 38 bp, Artificial Sequence
  Description of Artificial Sequence Synthetic primer
gcctccctcgcgccatcagagttccagggcagagtcac

SEQ ID NO: 254 - DNA, 19 bp, Artificial Sequence
  Description of Artificial Sequence Synthetic primer
agtttcagggcagggtcac

SEQ ID NO: 255 - DNA, 38 bp, Artificial Sequence
  Description of Artificial Sequence Synthetic primer
gcctccctcgcgccatcagagtttcagggcagggtcac

SEQ ID NO: 256 - DNA, 19 bp, Artificial Sequence
  Description of Artificial Sequence Synthetic primer
agttccaggaaagagtcac

SEQ ID NO: 257 - DNA, 38 bp, Artificial Sequence
  Description of Artificial Sequence Synthetic primer
gcctccctcgcgccatcagagttccaggaaagagtcac

SEQ ID NO: 258 - DNA, 19 bp, Artificial Sequence
  Description of Artificial Sequence Synthetic primer
aattccaggacagagtcac

SEQ ID NO: 259 - DNA, 38 bp, Artificial Sequence
  Description of Artificial Sequence Synthetic primer
gcctccctcgcgccatcagaattccaggacagagtcac

SEQ ID NO: 260 - DNA, 20 bp, Artificial Sequence
  Description of Artificial Sequence Synthetic primer
tctctgggttctcactcagc

SEQ ID NO: 261 - DNA, 20 bp, Artificial Sequence
  Description of Artificial Sequence Synthetic primer
aaggccctggagtggcttgc

SEQ ID NO: 262 - DNA, 39 bp, Artificial Sequence
  Description of Artificial Sequence Synthetic primer
gcctccctcgcgccatcagaaggccctggagtggcttgc

SEQ ID NO: 263 - DNA, 20 bp, Artificial Sequence
  Description of Artificial Sequence Synthetic primer
tccctgagactctcctgtgc

SEQ ID NO: 264 - DNA, 20 bp, Artificial Sequence
  Description of Artificial Sequence Synthetic primer
ctctcctgtgcagcctctgg

SEQ ID NO: 265 - DNA, 20 bp, Artificial Sequence
  Description of Artificial Sequence Synthetic primer
ggtccctgagactctcctgt

SEQ ID NO: 266 - DNA, 20 bp, Artificial Sequence
  Description of Artificial Sequence Synthetic primer
ctgagactctcctgtgtagc

SEQ ID NO: 267 - DNA, 18 bp, Artificial Sequence
  Description of Artificial Sequence Synthetic primer
ctccagggaaggggctgg

SEQ ID NO: 268 - DNA, 37 bp, Artificial Sequence
  Description of Artificial Sequence Synthetic primer
gcctccctcgcgccatcagctccagggaaggggctgg

SEQ ID NO: 269 - DNA, 18 bp, Artificial Sequence
  Description of Artificial Sequence Synthetic primer
ggctccaggcaaggggct

SEQ ID NO: 270 - DNA, 37 bp, Artificial Sequence
  Description of Artificial Sequence Synthetic primer
gcctccctcgcgccatcagggctccaggcaaggggct

SEQ ID NO: 271 - DNA, 19 bp, Artificial Sequence
  Description of Artificial Sequence Synthetic primer
actgggtccgccaggctcc

SEQ ID NO: 272 - DNA, 38 bp, Artificial Sequence
  Description of Artificial Sequence Synthetic primer
gcctccctcgcgccatcagactgggtccgccaggctcc

SEQ ID NO: 273 - DNA, 18 bp, Artificial Sequence
  Description of Artificial Sequence Synthetic primer
gaaggggctggagtgggt

SEQ ID NO: 274 - DNA, 37 bp, Artificial Sequence
  Description of Artificial Sequence Synthetic primer
gcctccctcgcgccatcaggaaggggctggagtgggt

SEQ ID NO: 275 - DNA, 18 bp, Artificial Sequence
  Description of Artificial Sequence Synthetic primer
aaaaggtctggagtgggt

SEQ ID NO: 276 - DNA, 37 bp, Artificial Sequence
  Description of Artificial Sequence Synthetic primer
gcctccctcgcgccatcagaaaaggtctggagtgggt

SEQ ID NO: 277 - DNA, 20 bp, Artificial Sequence
  Description of Artificial Sequence Synthetic primer
agaccctgtccctcacctgc

SEQ ID NO: 278 - DNA, 20 bp, Artificial Sequence
  Description of Artificial Sequence Synthetic primer
agggvctggagtggattggg

SEQ ID NO: 279 - DNA, 39 bp, Artificial Sequence
  Description of Artificial Sequence Synthetic primer
gcctccctcgcgccatcagagggvctggagtggattggg

SEQ ID NO: 280 - DNA, 20 bp, Artificial Sequence
  Description of Artificial Sequence Synthetic primer
gcgccagatgcccgggaaag

SEQ ID NO: 281 - DNA, 20 bp, Artificial Sequence
  Description of Artificial Sequence Synthetic primer
ggccasgtcaccatctcagc

SEQ ID NO: 282 - DNA, 39 bp, Artificial Sequence
  Description of Artificial Sequence Synthetic primer
gcctccctcgcgccatcagggccasgtcaccatctcagc

SEQ ID NO: 283 - DNA, 20 bp, Artificial Sequence
  Description of Artificial Sequence Synthetic primer
ccggggacagtgtctctagc

SEQ ID NO: 284 - DNA, 20 bp, Artificial Sequence
  Description of Artificial Sequence Synthetic primer
gccttgagtggctgggaagg

SEQ ID NO: 285 - DNA, 39 bp, Artificial Sequence
  Description of Artificial Sequence Synthetic primer
gcctccctcgcgccatcaggccttgagtggctgggaagg

SEQ ID NO: 286 - DNA, 20 bp, Artificial Sequence
  Description of Artificial Sequence Synthetic primer
gtttcctgcaaggcttctgg

SEQ ID NO: 287 - DNA, 20 bp, Artificial Sequence
  Description of Artificial Sequence Synthetic primer
ggcttgagtggatgggatgg

SEQ ID NO: 288 - DNA, 39 bp, Artificial Sequence
  Description of Artificial Sequence Synthetic primer
gcctccctcgcgccatcagggcttgagtggatgggatgg

SEQ ID NO: 289 - DNA, 19 bp, Artificial Sequence
  Description of Artificial Sequence Synthetic primer
acctgaggagacggtgacc

SEQ ID NO: 290 - DNA, 20 bp, Artificial Sequence
  Description of Artificial Sequence Synthetic primer
cagtgctggaagtattcagc

SEQ ID NO: 291 - DNA, 39 bp, Artificial Sequence
  Description of Artificial Sequence Synthetic primer
gccttgccagcccgctcagcagtgctggaagtattcagc

SEQ ID NO: 292 - DNA, 20 bp, Artificial Sequence
  Description of Artificial Sequence Synthetic primer
agagatcgaagtaccagtag

SEQ ID NO: 293 - DNA, 39 bp, Artificial Sequence
  Description of Artificial Sequence Synthetic primer
gccttgccagcccgctcagagagatcgaagtaccagtag

SEQ ID NO: 294 - DNA, 20 bp, Artificial Sequence
  Description of Artificial Sequence Synthetic primer
ccccagatatcaaaagcatc

SEQ ID NO: 295 - DNA, 39 bp, Artificial Sequence
  Description of Artificial Sequence Synthetic primer
gccttgccagcccgctcagccccagatatcaaaagcatc

SEQ ID NO: 296 - DNA, 20 bp, Artificial Sequence
  Description of Artificial Sequence Synthetic primer
ggccccagtagtcaaagtag

SEQ ID NO: 297 - DNA, 39 bp, Artificial Sequence
  Description of Artificial Sequence Synthetic primer
gccttgccagcccgctcagggccccagtagtcaaagtag

SEQ ID NO: 298 - DNA, 20 bp, Artificial Sequence
  Description of Artificial Sequence Synthetic primer
cccaggggtcgaaccagttg

SEQ ID NO: 299 - DNA, 39 bp, Artificial Sequence
  Description of Artificial Sequence Synthetic primer
gccttgccagcccgctcagcccaggggtcgaaccagttg

SEQ ID NO: 300 - DNA, 20 bp, Artificial Sequence
  Description of Artificial Sequence Synthetic primer
cccagacgtccatgtagtag

SEQ ID NO: 301 - DNA, 39 bp, Artificial Sequence
  Description of Artificial Sequence Synthetic primer
gccttgccagcccgctcagcccagacgtccatgtagtag

SEQ ID NO: 302 - DNA, 20 bp, Artificial Sequence
  Description of Artificial Sequence Synthetic primer
taggagacagagtcaccatc

SEQ ID NO: 303 - DNA, 20 bp, Artificial Sequence
  Description of Artificial Sequence Synthetic primer
ttcagygrcagtggatctgg

SEQ ID NO: 304 - DNA, 39 bp, Artificial Sequence
  Description of Artificial Sequence Synthetic primer
gcctccctcgcgccatcagttcagygrcagtggatctgg

SEQ ID NO: 305 - DNA, 20 bp, Artificial Sequence
  Description of Artificial Sequence Synthetic primer
ggagagccggcctccatctc

SEQ ID NO: 306 - DNA, 20 bp, Artificial Sequence
  Description of Artificial Sequence Synthetic primer
tggtacctgcagaagccagg

SEQ ID NO: 307 - DNA, 39 bp, Artificial Sequence
  Description of Artificial Sequence Synthetic primer
gcctccctcgcgccatcagtggtacctgcagaagccagg

SEQ ID NO: 308 - DNA, 20 bp, Artificial Sequence
  Description of Artificial Sequence Synthetic primer
cttcagcagaggccaggcca

SEQ ID NO: 309 - DNA, 39 bp, Artificial Sequence
  Description of Artificial Sequence Synthetic primer
gcctccctcgcgccatcagcttcagcagaggccaggcca

SEQ ID NO: 310 - DNA, 20 bp, Artificial Sequence
  Description of Artificial Sequence Synthetic primer
gcctggtaccagcagaaacc

SEQ ID NO: 311 - DNA, 20 bp, Artificial Sequence
  Description of Artificial Sequence Synthetic primer
gccaggttcagtggcagtgg

SEQ ID NO: 312 - DNA, 39 bp, Artificial Sequence
  Description of Artificial Sequence Synthetic primer
gcctccctcgcgccatcaggccaggttcagtggcagtgg

SEQ ID NO: 313 - DNA, 20 bp, Artificial Sequence
  Description of Artificial Sequence Synthetic primer
tcgaggttcagtggcagtgg

SEQ ID NO: 314 - DNA, 39 bp, Artificial Sequence
  Description of Artificial Sequence Synthetic primer
gcctccctcgcgccatcagtcgaggttcagtggcagtgg

SEQ ID NO: 315 - DNA, 20 bp, Artificial Sequence
  Description of Artificial Sequence Synthetic primer
gaccgattcagtggcagcgg

SEQ ID NO: 316 - DNA, 39 bp, Artificial Sequence
  Description of Artificial Sequence Synthetic primer
gcctccctcgcgccatcaggaccgattcagtggcagcgg

SEQ ID NO: 317 - DNA, 20 bp, Artificial Sequence
  Description of Artificial Sequence Synthetic primer
ttcaactgctcatcagatgg

SEQ ID NO: 318 - DNA, 20 bp, Artificial Sequence
  Description of Artificial Sequence Synthetic primer
atgaagacagatggtgcagc

SEQ ID NO: 319 - DNA, 39 bp, Artificial Sequence
  Description of Artificial Sequence Synthetic primer
gccttgccagcccgctcagatgaagacagatggtgcagc

SEQ ID NO: 320 - DNA, 20 bp, Artificial Sequence
  Description of Artificial Sequence Synthetic primer
gggcagagggtcaccatctc

SEQ ID NO: 321 - DNA, 20 bp, Artificial Sequence
  Description of Artificial Sequence Synthetic primer
ggacagaaggtcaccatctc

SEQ ID NO: 322 - DNA, 20 bp, Artificial Sequence
  Description of Artificial Sequence Synthetic primer
tggtaccagcagctcccagg

SEQ ID NO: 323 - DNA, 39 bp, Artificial Sequence
  Description of Artificial Sequence Synthetic primer
gcctccctcgcgccatcagtggtaccagcagctcccagg

SEQ ID NO: 324 - DNA, 20 bp, Artificial Sequence
  Description of Artificial Sequence Synthetic primer
tggtaccagcagcttccagg

SEQ ID NO: 325 - DNA, 39 bp, Artificial Sequence
  Description of Artificial Sequence Synthetic primer
gcctccctcgcgccatcagtggtaccagcagcttccagg

SEQ ID NO: 326 - DNA, 20 bp, Artificial Sequence
  Description of Artificial Sequence Synthetic primer
ctgcactggaaccagcagtg

SEQ ID NO: 327 - DNA, 20 bp, Artificial Sequence
  Description of Artificial Sequence Synthetic primer
tctctggctccaagtctggc

SEQ ID NO: 328 - DNA, 39 bp, Artificial Sequence
  Description of Artificial Sequence Synthetic primer
gcctccctcgcgccatcagtctctggctccaagtctggc

SEQ ID NO: 329 - DNA, 20 bp, Artificial Sequence
  Description of Artificial Sequence Synthetic primer
accagcagaagccaggccag

SEQ ID NO: 330 - DNA, 20 bp, Artificial Sequence
  Description of Artificial Sequence Synthetic primer
gaagccaggacaggcccctg

SEQ ID NO: 331 - DNA, 20 bp, Artificial Sequence
  Description of Artificial Sequence Synthetic primer
ctgagcgattctctggctcc

SEQ ID NO: 332 - DNA, 39 bp, Artificial Sequence
  Description of Artificial Sequence Synthetic primer
gcctccctcgcgccatcagctgagcgattctctggctcc

SEQ ID NO: 333 - DNA, 20 bp, Artificial Sequence
  Description of Artificial Sequence Synthetic primer
ttctctgggtccacctcagg

SEQ ID NO: 334 - DNA, 39 bp, Artificial Sequence
  Description of Artificial Sequence Synthetic primer
gcctccctcgcgccatcagttctctgggtccacctcagg

SEQ ID NO: 335 - DNA, 20 bp, Artificial Sequence
  Description of Artificial Sequence Synthetic primer
ttctctggctccagctcagg

SEQ ID NO: 336 - DNA, 39 bp, Artificial Sequence
  Description of Artificial Sequence Synthetic primer
gcctccctcgcgccatcagttctctggctccagctcagg

SEQ ID NO: 337 - DNA, 20 bp, Artificial Sequence
  Description of Artificial Sequence Synthetic primer
tcggtcaagctcacctgcac

SEQ ID NO: 338 - DNA, 39 bp, Artificial Sequence
  Description of Artificial Sequence Synthetic primer
gcctccctcgcgccatcaggggctgaccgctacctcacc

SEQ ID NO: 339 - DNA, 20 bp, Artificial Sequence
  Description of Artificial Sequence Synthetic primer
cagcctgtgctgactcagcc

SEQ ID NO: 340 - DNA, 20 bp, Artificial Sequence
  Description of Artificial Sequence Synthetic primer
ccagccgcttctctggatcc

SEQ ID NO: 341 - DNA, 39 bp, Artificial Sequence
  Description of Artificial Sequence Synthetic primer
gcctccctcgcgccatcagccagccgcttctctggatcc

SEQ ID NO: 342 - DNA, 20 bp, Artificial Sequence
  Description of Artificial Sequence Synthetic primer
ccatctcctgcacccgcagc

SEQ ID NO: 343 - DNA, 20 bp, Artificial Sequence
  Description of Artificial Sequence Synthetic primer
tccccwggagggacagtcac

SEQ ID NO: 344 - DNA, 20 bp, Artificial Sequence
  Description of Artificial Sequence Synthetic primer
ctcmcctgcaccctgagcag

SEQ ID NO: 345 - DNA, 20 bp, Artificial Sequence
  Description of Artificial Sequence Synthetic primer
agaccgccacactcacctgc

SEQ ID NO: 346 - DNA, 20 bp, Artificial Sequence
  Description of Artificial Sequence Synthetic primer
ctgatcgsttctctggctcc

SEQ ID NO: 347 - DNA, 39 bp, Artificial Sequence
  Description of Artificial Sequence Synthetic primer
gcctccctcgcgccatcagctgatcgsttctctggctcc

SEQ ID NO: 348 - DNA, 20 bp, Artificial Sequence
  Description of Artificial Sequence Synthetic primer
ctgcccggttctcaggctcc

SEQ ID NO: 349 - DNA, 20 bp, Artificial Sequence
  Description of Artificial Sequence Synthetic primer
atccaggaagaggatgagag

SEQ ID NO: 350 - DNA, 39 bp, Artificial Sequence
  Description of Artificial Sequence Synthetic primer
gcctccctcgcgccatcagatccaggaagaggatgagag

SEQ ID NO: 351 - DNA, 20 bp, Artificial Sequence
  Description of Artificial Sequence Synthetic primer
ctccagcctgaggacgaggc

SEQ ID NO: 352 - DNA, 39 bp, Artificial Sequence
  Description of Artificial Sequence Synthetic primer
gcctccctcgcgccatcagctccagcctgaggacgaggc

SEQ ID NO: 353 - DNA, 20 bp, Artificial Sequence
  Description of Artificial Sequence Synthetic primer
gctcccgggtagaagtcact

SEQ ID NO: 354 - DNA, 20 bp, Artificial Sequence
  Description of Artificial Sequence Synthetic primer
agtgtggccttgttggcttg

SEQ ID NO: 355 - DNA, 39 bp, Artificial Sequence
  Description of Artificial Sequence Synthetic primer
gccttgccagcccgctcagagtgtggccttgttggcttg

SEQ ID NO: 356 - DNA, 19 bp, Artificial Sequence
  Description of Artificial Sequence Synthetic primer
gcctccctcgcgccatcag

SEQ ID NO: 357 - DNA, 19 bp, Artificial Sequence
  Description of Artificial Sequence Synthetic primer
gccttgccagcccgctcag

SEQ ID NO: 358 - DNA, 20 bp, Artificial Sequence
  Description of Artificial Sequence Synthetic primer
gggctgaccgctacctcacc

(19) United States
(12) Patent Application Publication
(10) Pub. No.: US 2016/0034637 A1
(43) Pub. Date: Feb. 4, 2016

(54) METHOD FOR EVALUATING AN IMMUNOREPERTOIRE

(71) Applicant: CB BIOTECHNOLOGIES, INC., Huntsville, AL (US)

(72) Inventors: Chunlin Wang, Menlo Park, CA (US); Jian Han, Huntsville, AL (US)

(21) Appl. No.: 14/767,178

(22) PCT Filed: Feb. 11, 2014
(86) PCT No.: PCT/US14/15841

§ 371 Date: Aug. 11, 2015

Related U.S. Application Data
(60) Provisional application No. 61/763,451, filed on Feb. 11, 2013.

(51) Int. Cl. G06F 19/22; G06F 19/28; G06F 19/24; C40B 30/02

(52) U.S. Cl. CPC G06F 19/22; C40B 30/02; G06F 19/28; G06F 19/24

(57) ABSTRACT

Disclosed is a method for amplifying RNA from T and B-cell populations and using the amplified RNA products to evaluate the possible correlation between a normal or abnormal immune response and the development of a disease such as an autoimmune disease, cancer, diabetes, or heart disease.

### CROSS REFERENCE TO RELATED APPLICATION

This application is a continuation of and claims priority to U.S. Provisional Application No. 61/763,341, entitled “Method for Evaluating an Immunorepertoire” and filed on Feb. 11, 2013, which is incorporated herein by reference.

### SEQUENCE LISTING

The instant application contains a Sequence Listing which has been submitted electronically in ASCII format and is hereby incorporated by reference in its entirety. Said ASCII copy, created on Feb. 5, 2014, is named 15892-0005_SL.txt and is 93,776 bytes in size.

### FIELD OF THE INVENTION

The invention relates to methods for identifying T-cell receptor antibody in a population of cells and methods for using that information to measure immune status of a patient and predict the likelihood of which disease the patient might have.

### BACKGROUND OF THE INVENTION

Scientists have known for a number of years that certain discos associated with particular genes or genetic mutations. Genetic causation, however, accounts for only a portion the diseases diagnosed in humans. Many diseases appear to be linked in some way to the immune system's response to infectious and environmental agents, but bow the immune system plays a role in diseases such as cancer, Alzheimer's, costochondritis, fibromyalgia, lupus, and other diseases is still being determined.

The human genome comprises a total number of 567-588 IG (immunoglobulin) and TR (T cell receptor) genes (339-354 IG and 228-234 TR) per haploid genome, localized in the 7 major loci. They comprise 405-418 V, 32 D, 105-109 J and 25-29 C genes. The number of functional IG and TR genes is 321-353 per haploid genome. They comprise 187-215 V, 28 D, 86-88 J and 20-21 C genes (http://imgt.cines.fr). Through rearrangement of these genes, an estimated 2.5×10² possible antibodies or T cell receptors can be generated.

A few diseases to date have been associated with the body's reaction to a common antigen (Prinz, J. et al., Eur. J. Immunol. (1999) 29(10): 3360-3368, “Selection of Conserved TCR VDJ Rearrangements in Chronic Psoriatic Plaques Indicates a Common Antigen in Psoriasis Vulgaris) and/or to specific VDJ rearrangements (Tamaru, J. et al., Blood (1994) 84(3): 708-715. “Hodgkin's Disease with a B-cell Phenotype Often Shows a VDJ Rearrangement and Somatic Mutations in the VH Genes). What is needed is a better method for evaluating changes in human immune response cells and associating those changes with specific diseases.

### SUMMARY OF THE INVENTION

The invention relates to a method for evaluating changes in immune response populations and associating those changes with a specific disease. In one aspect of the invention, the method composes the steps of (a) isolating a subpopulation of white blood cells from at least one human or animal subject, (b) isolating RNA from the subpopulation of cells, (c) amplifying the RNA using RT-PCR in a first amplification reaction to produce amplicons using nested primers, at least a portion of the nested primers comprising additional nucleotides to incorporate into a resulting amplicon a binding site for a communal primer, (d) separating the amplicons from the first amplification reaction from one or more unused primers from the first amplification reaction, (e) amplifying, by the addition of communal primers in a second amplification reaction, the amplicons of the first amplification reaction having at least one binding site for a communal primer, and (f) sequencing the amplicons of the second amplification reaction to identify antibody and,or receptor rearrangements in the subpopulation of cells. In one embodiment, the subpopulation may comprise a whole blood population or another mixed population sample.

In one embodiment, the step of isolating a subpopulation of white blood cells may be performed by flow cytometry to separate naïve B cells, mature B cells, memory B cells, naïve T cells, mature T cells, and memory T cells. In various embodiments of the method, the recombinations in the subpopulation of cells are rearrangements of B-cell immunoglobulin heavy chain (IgH), kappa and/or lambda light chains (IgK, IgL) T-cell receptor Alpha Beta, Gamma, Delta. In an additional embodiment.

In another aspect of the invention, the method may optionally comprise an additional step comprising (g) comparing the rearrangements identified for a population of individuals to whom a vaccine has been administered with the rearrangements identified for a population of individuals to whom the vaccine was not administered to evaluate the efficacy of the vaccine in producing an immune response.

The method may also optionally comprise the additional step of (g) comparing the rearrangements identified for a population of normal individuals with the rearrangements identified for a population of individuals who have been diagnosed with a disease to determine if there is a correlation between a specific rearrangement or set of rearrangements and the disease.

In various aspects, the method can produce semi-quantitative amplification of polynucleotides comprising complementarity determining region 3 (CDR3s), which result from genetic rearrangements within T or B cells and are responsible for the affinity and specificity of antibodies and/or T cell receptors for specific antigens. Semi-quantitative amplification provides a method to not only detect the presence of specific CDR3 sequences, but also determine the relative abundance of cells which have produced the necessary recombination events to produce those CDR3 sequences.

One aspect of the invention therefore relates to a method for analyzing semi-quantitative sequence information to provide one or more immune status reports for a human or animal. The method for producing an immune status report comprising the steps of (a) identifying one or more distinct CDR3 sequences that are shared between a subject's immunoprofile and a cumulative immunoprofile from a disease library stored in a database, summing a total number of a subjects detected sequences corresponding to those shared distinct CDR3 sequences, and computing the percentage of the total number of detected sequences in the subject's immunoprofile that are representative of those distinct CDR3s shared between the subject's immunoprofile and the disease library to create one or more original sharing indices, (b) randomly selecting sequences from a public library stored in a database to form a sub-library, the sub-library comprising a number of sequences that is approximately equal to the number of distinct CDR3 sequences in the disease library, identifying one or more distinct CDR3 sequences that are shared between the subject's immunoprofile and the sub-library, summing a total number of detected sequences corresponding to those shared CDR3 sequences, and calculating a percentage of the total number of detected sequences in the subject's immunoprofile that are shared between the subject's immunoprofile and the sub-library to create a sampling sharing index (c) repeating step (b) at least 1000 or more times and (d) estimating the P-value as the fraction of times the sampling sharing indices are greater then or equal to the original sharing index between a patient's immunoprofile and a disease library.

### BRIEF DESCRIPTION OF THE DRAWINGS

The disclosure can be better understood with reference to the following drawings. The elements of the drawings are not necessarily to scale relative to each other, emphasis instead being placed upon dearly illustrating the principles of the disclosure. Furthermore, like reference numerals designate corresponding parts throughout the several views.

FIG. 1a and FIG. 1b are photographs of gel illustrating the presence of amplification products obtained by the method of the invention using primers disclosed herein.

FIG. 2a and FIG. 2b are cartoons representing the observed difference in diversity between an immunoprofile in an individual with a disease and an individual who is generally healthy, with each filled circle representing a distinct CDR3 sequence and the size of the circle representing the number of times that the distinct CDR3 sequence is found in the immunoprofile.

FIG. 3 is a diagram illustrating the method for generating a public library.

FIG. 4 is a diagram illustrating the method for generating a disease library.

FIG. 5 illustrates results obtained by comparing a patient immunoprofile with a disease library, calculating a percentage for each distinct CDR3 in the patient immunoprofile that is shared between the two, and adding those percentages to produce a sum, or sharing index.

FIG. 6 illustrates results obtained by comparing a patient immunoprofile with a subset of a public library, calculating a percentage for each distinct CDR3 that is shared between the two, and adding those percentages in the patient immunoprofile produce a sum, or sharing index.

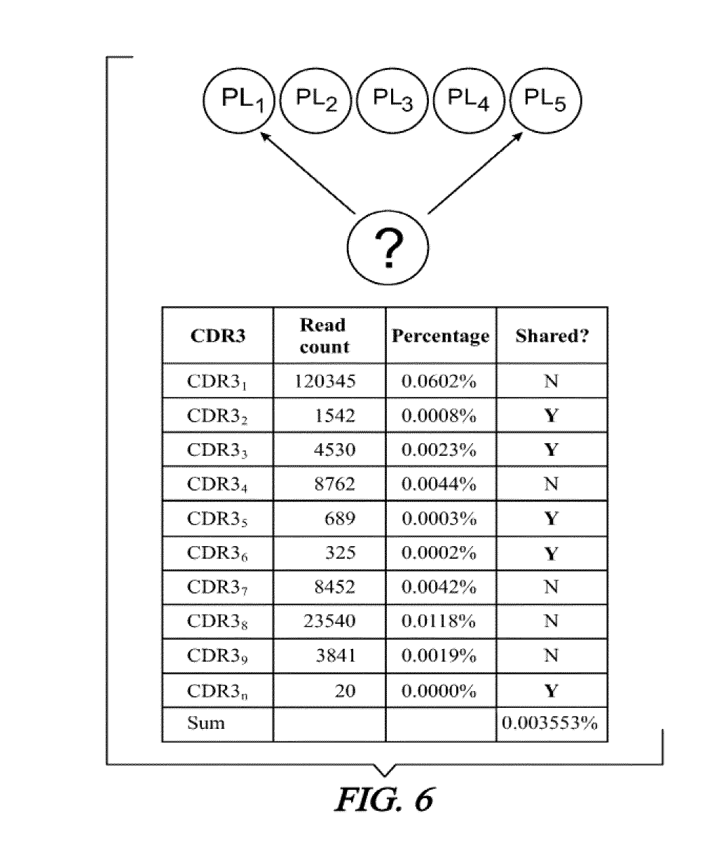

FIG. 7 is a graph illustrating the method of the invention, where the area under the curve represents total sharing indices obtained for subsets of a public library (sub-libraries), a P-value is estimated, and sharing indices for comparisons of an individual's immunoprofile and one or more disease libraries are represented by vertical lines (DL₁, DL₂, etc.).

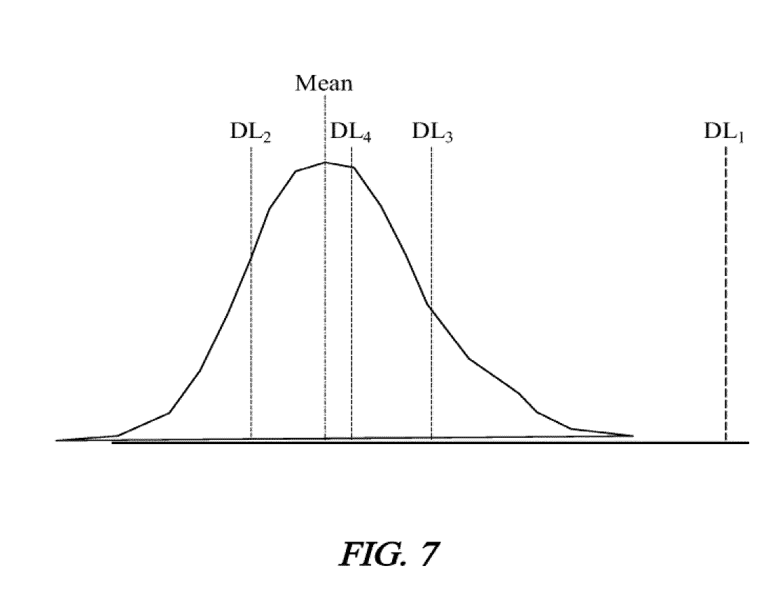

### DETAILED DESCRIPTION

The inventors have developed methods for evaluating antibody and T cell receptor rearrangements from a large number of cells, the methods being useful for comparing rearrangements identified in populations of individuals to determine whether there is a correlation between a specific rearrangement or set of rearrangements and a disease, or certain symptom of a disease. The method is also useful for establishing a history of the immune response of an individual or individuals in response to infectious and/or environmental agents as well as for evaluating the efficacy of vaccines.

The invention relates to a method for evaluating changes in immune response cell populations and associating those changes with a specific disease. In one aspect of the invention, the method comprises the amps of (a) isolating a subpopulation of white blood cells from at least one human or animal subject, (b) isolating RNA from the subpopulation of cells, (c) amplifying the RNA using RT-PCR in a first amplification reaction to produce amplicons using nested primers at least a portion of the nested primers comprising additional nucleotides to incorporate into a resulting amplicon a binding site for a communal primer, (d) separating the amplicons from the first amplification reaction from one or more unused primers from the first amplification reaction, (e) amplifying, by the addition of communal primers in a second amplification reaction, the amplicons of the first amplification reaction having at least one binding site for a communal primer, and (f) sequencing the amplicons of the second amplification reaction to identify antibody and/or receptor rearrangements in the subpopulation of cells. In one embodiment, the subpopulation may comprise a whole blood population or another mixed population sample.

In one embodiment, a peripheral blood sample is taken from a patient and the step of isolating a subpopulation of white blood cells may be performed by flow cytometry to separate naïve B cells, mature B cells, memory B cells, naïve T cells, mature T cells, and memory T cells. In various embodiments of the method, the recombinations in the subpopulation of cells are rearrangements of B-cell immunoglobulin heavy chain (IgH), kappa and/or lamba light chains (IgK, IgL), T-cell receptor Beta, Gamma, or Delta.

In a second aspect of the invention, the method may comprise an additional step (g) comparing the rearrangements identified for a population of normal individuals with the rearrangements identified for a population of individuals who have been diagnosed with a disease to determine if there is a correlation between a specific rearrangement or set of rearrangements and the disease.

In another aspect of the invention, the method may comprise an additional step comprising (g) comparing the rearrangements identified for a population of individuals to whom a vaccine has been administered with the rearrangements identified for a population of individuals to whom the vaccine was not administered to evaluate the efficacy of the vaccine in producing an immune response.

In some embodiments, the step of separating the amplicons from the first amplification reaction from one or more unused primers from the first amplification reaction may be omitted and the two amplification reactions may be performed in the same reaction tube.

The inventor previously developed a PCR method known as tem-PCR, which has been described in publication number WO20051038039, the disclosure of which is herein incorporated by reference in its entirety. More recently, the inventor has developed a method called arm-PCR, which was described in U.S. provisional patent application No. 61/042,259, the disclosure of which is herein incorporated by reference in its entirety. Also described is an apparatus for detecting target polynucleotides in a sample, the apparatus comprising a first amplification chamber for thermocycling to amplify one or more target polynucleotides to produce amplicons using nested primers, at least a portion of the nested primers composing additional nucleotides to incorporate into a resulting amplicon a binding site for a communal primer; a means for separating the amplicons from the first amplification reaction from one or more unused primers from the first amplification reaction and a second amplification chamber for thermocycling to amplify one or more amplicons produced during the first amplification reaction by the addition of communal primers in a second amplification reaction, the amplicons of the first amplification reaction having at least one binding site for at least one communal primer.

Also described is a PCR chip comprising a first PCR chamber fluidly connected to both a waste reservoir and a second PCR chamber, the waste reservoir and second PCR chamber each additionally comprising at least one electrode, the electrodes comprising, a means for separating amplicons produced from the first PCR chamber. The second PCR chamber is fluidly connected to a hybridization and detection chamber, the hybridization and detection chamber comprising microspheres, or beads, arranged so that the physical position of the beads is an indication of a specific target polynucleotide's presence in the sampled analyzed by means of the chip.

The tem-PCR, and especially the arm-PCR, methods provide semi-quantitative amplification of multiple polynucleotides in one reaction. Additionally, arm-PCR provides added sensitivity. Both provide the ability to amplify multiple polynucleotides in one reaction, which is beneficial in the present method because the repertoire of various T and B cells, for example, is so large. The addition of a communal primer binding site in the amplification reaction, and the subsequent amplification of target molecules using communal primers, gives a quantitative, or semi-quantitative result—making it possible to determine the relative amounts of the cells comprising various rearrangements within a patient blood sample. Clonal expansion due to recognition of antigen results in a larger population of cells which recognize that antigen, and evaluating cells by their relative numbers provides, a method for determining whether an antigen exposure has influenced expansion of antibody-producing B cells or receptor-bearing T cells. This is helpful for evaluating whether there may be a particular population of cells that is prevalent in individuals who have been diagnosed with a particular disease, for example, and may be especially helpful in evaluating whether or not a vaccine has achieved the desired immune response in individuals to whom the vaccine has been given.

There are several commercially available high throughput sequencing technologies, such as Roche Life Sciences's 454 sequencing. In the 454 sequencing method, 454A and 454B primers are linked onto PCR products either during PCR or ligated on after the PCR reaction. When done in conjunction with tem-PCR or arm-PCR, 454A and 454B primers may be used as communal primers in the amplification reactions. PCR products, usually a mixture of different sequences, are diluted to about 200 copies per μl. In an “emulsion PCR” reaction, (a semisolid gel like environment) the diluted PCR products are amplified by primers (454A or 454B) on the surface of the microbeads. Because the PCR templates are so dilute, usually only one bead is adjacent to one template, and confined in the semisolid environment, amplification only occurs on and around the beads. The beads are then eluted and put onto a plate with specially designed wells. Each well can only hold one bead. Reagents are then added into the wells to came out pyrosequencing. A fiber-optic detector may be used to read the sequencing reaction from each well and the data is collected in parallel by a computer. One such high throughput reaction could generate up to 60 million reads (60 million beads) and each read can generate about 300 bp sequences.

One aspect of the invention involves the development of a database of “personal immunorepertoires,” or immunoprofiles, so that each individual may establish a baseline and follow the development of immune responses to antigens, both known and unknown, over a period of years. This information may, if information is gathered from a large number of individuals, provide an epidemiological database that will produce valuable information, particularly in regard to the development of those diseases, such as cancer and heart disease, which are thought to often arise from exposure to viral or other infectious agents or transformed cells, many of which have as yet been unidentified. One particularly important use for the method of the invention involves the evaluation of children to determine whether infectious disease, environmental agents, or vaccines may be the cause of autism. For example, many have postulated that vaccine administration may trigger the development of autism. However, many also attribute that potential correlation to the use of agents such as thimerosol in the vaccine, and studies have demonstrated that thimerosol does not appear to be a causative agent of the disease. There is still speculation that the development of cocktail vaccines has correlated with the rise in the number of cases of autism, however, gathering data to evaluate a potential causal connection for multiple antigens is extremely difficult. The method of the present invention simplifies that process and may provide key information for a better understanding of autism and other diseases in which the immune response of different individuals may provide an explanation for the differential development of disease in some individuals exposed to an agent or a group of agents, while others similarly exposed do not develop the disease.

Imbalances of the immunoprofile, triggered by infection, may lead to many diseases, including cancers, leukemia, neuronal diseases (Alzheimer's, Multiple Sclerosis, Parkinson's, autism etc.), autoimmune diseases, and metabolic diseases. These diseases may be celled immunoprofile diseases. There may be two immunoprofile disease forms. (1) a “loss of function” form, and (2) a “gain of function” form, in the “loss of function” form, a person is susceptible to a disease because his/her restricted and/or limited immunoprofile lacks the cells that produce the most efficient and necessary IGs and TRs. In the “gain of function” form, a person is susceptible to a disease because his/her immunoprofile gained cells that produce IGs and TRs that normally should not be there. In the “loss of a function” (LOF) immunoprofile diseases, an individual does not have the appropriate functional B or T cells to fight a disease. His/her HLA typing has determined that those cells are eliminated during the early stages of the immune cell maturation process, the cells generally being eliminated because they react to strongly to his/her own proteins.

One aspect of the invention also provides a method comprising (a) amplifying and sequencing one or more RNAs from the T cells and/or B cells from one or more individuals, (b) inputting the sequences into a database to provide data which may be stored on a computer, server, or other electronic storage device, (c) inputting identifying information and characteristics for an individual corresponding to the sequences of the one or more RNAs as data which may also be stored on a computer, server, or other electronic storage device, and (d) evaluating the data of step (b) end step (e) for one or more individuals to determine whether a conviction exists between the one or more RNA sequences and one or more characteristics of the individual corresponding to the sequence(s). Identifying information may include, for example, a patient identification number, a code comprising the patient's HLA type, a disease code comprising one or more clinical diagnoses that may have been made, a “staging code” comprising the date of the sample, a cell type code comprising the type of cell subpopulation from which the RNA was amplified and sequenced, and one or more sequence codes comprising the sequences identified for the sample.

The described method includes a novel primer design that riot only allows amplification of the entire immunorepertoire, but also allows amplification in a highly multiplex fashion and semiquantitatively. Multiplex amplification requires that only a few PCR or RT-PCR reactions will be needed. For example, all IGs may be amplified in one reaction, or it could be divided into two or three reactions for IgH, IgL or IgK. Similarly, the T-cell receptors (TRs) may be amplified in just one reaction, or may be amplified in a few reactions including TRA, TRB, TRD, and TRG. Semi-quantitative amplification means that all the targets in the multiplex reaction will be amplified independently, so that the end point analysis of the amplified products will reflect the original internal ratio among the targets.

In various aspects, the method can produce semi-quantitative amplification of polynucleotides comprising complementarity determining regions (CDRs), which result from genetic rearrangements within T or B cells and are responsible for the affinity and specificity of antibodies and/or T cell receptors for specific antigens. Semi-quantitative amplification provides a method to not only detect the presence of specific CDR3 sequences, but also determine the relative numbers of cells have produced the necessary recombination events to produce those CDR3 sequences.

One aspect of the invention therefore relates to a method for analyzing semi-quantitative sequence information to provide one or more immune status reports for a human or animal. The method for producing an immune status report comprising the steps of (a) identifying one or more distinct CDR3 sequences that are shared between a subject's immunoprofile and a disease library stored in a database summing the total of those shared CDR3 sequences and computing the percentage of the total number of sequences in the subject's immunoprofile that are shared between the subject's immunoprofile and the disease library to create one or more original sharing indices; (b) randomly selecting sequences from a public library stored in a database to form a sub-library, the sub-library comprising a number of sequences that is approximately equal to the number of distinct sequences in the disease library, identifying one or more distinct CDR3 sequences that are shared between the subject's immunoprofile and the sub-library, summing the total of those shared CDR3 sequences and calculating the percentage of the total number of sequences in the subject's immunoprofile that are shared between the subject's immunoprofile and the sub-library to create a sampling sharing index; (c) repeating step (b) at least 1000 or more times; and (d) estimating the P-value as the fraction of times the sampling sharing indices are greater than or equal to the original sharing index between a patient's immunoprofile and a disease library.

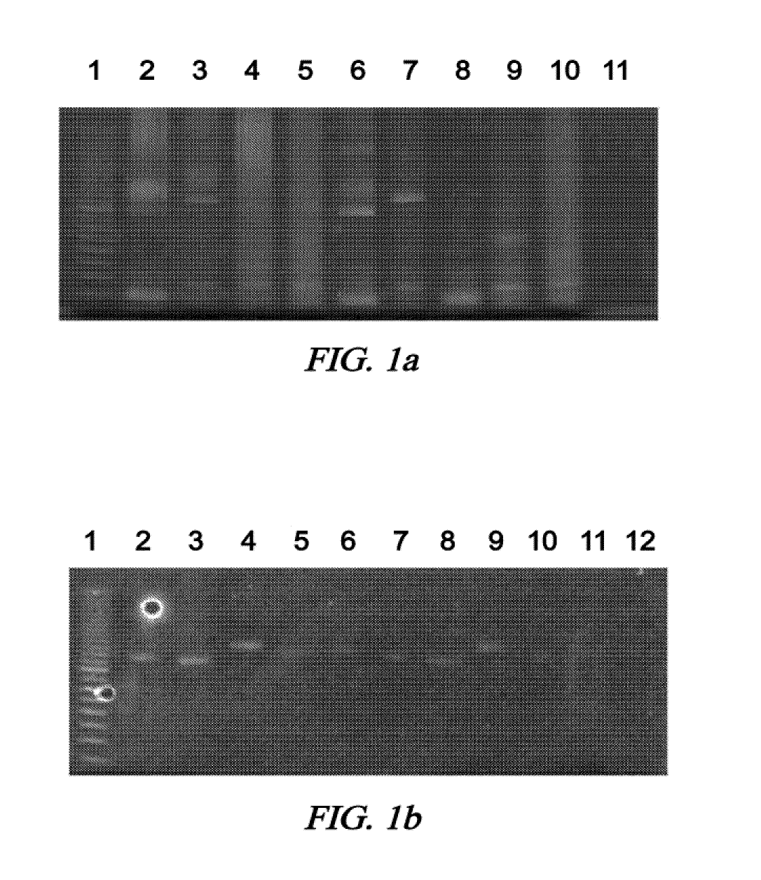

The inventors have discovered that the immunoprofile of individuals who have certain diseases, such as, for example, cancer, autoimmune disease, etc., may be characterized by a lack of diversity in one or more immune cell population(s). FIG. 1 is a cartoon illustrating the difference that may be observed between, for example, the distinct type and number of T-cells present in a blood sample from a cancer patient (FIG. 1a) and a healthy patient (FIG. 1b), where each circle represents a distinct type of T-cell, as represented by an amplified and sequenced recombined cDNA of the complementarity determining region of be T-cell receptor (e.g., CDR3), and the relative number of cells which are determined, by PCR amplification and sequencing, to share the same CDR3 sequence. As FIG. 1a indicates, these may be fewer distinct cells of different specificities, but larger numbers of cells of certain specificities, as represented by the CDR3 sequences. FIG. 1b illustrates a normal profile of more different cells, but fewer numbers of each type of cell sharing the same CDR3 sequence.

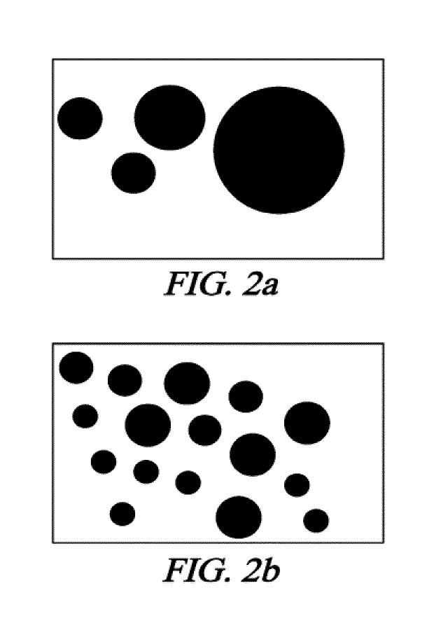

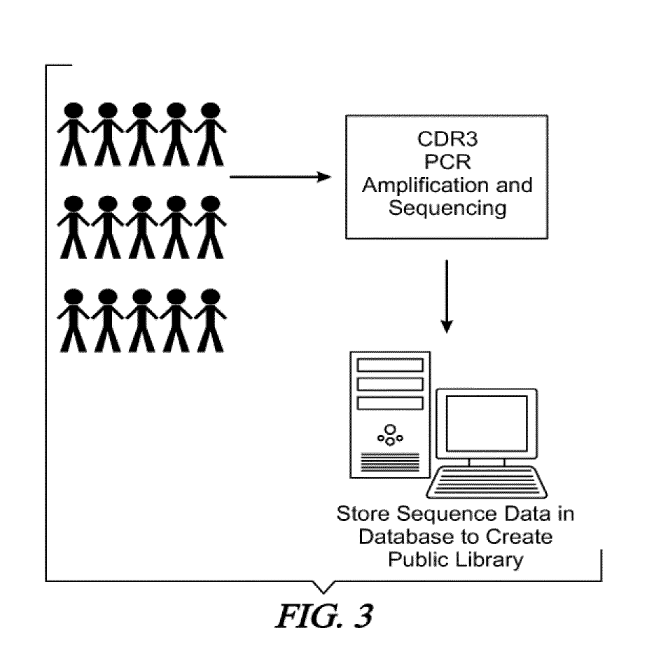

The list of each distinct CDR3-expressing cell, and the numbers of such cells represented within a blood or tissue sample from a human or animal, can constitute an immunoprofile for that human or animal. Compiling the immunoprofiles from a group of humans, for example, the group comprising both healthy individuals and individuals with various different diseases may provide a “public library” that is representative of the type of diversity found in a normal population (FIG. 2). Similarly, compiling the immunoprofiles of a group of individuals who have been clinically diagnosed with a particular disease may provide a “disease library” that is representative of the lack of diversity, the specific CDR3s of the expanded populations of cells, etc. (FIG. 3). These immunoprofiles may be stored in a database, accessible via computer access to the internet, for example, so that the information may be used in the method of the invention to analyze the immune status of a patient.

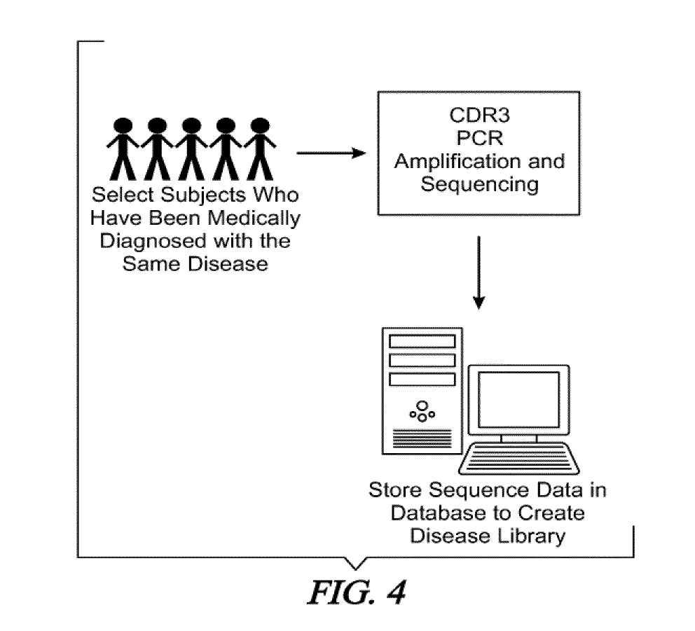

An immunoprofile, comprising a listing of distinct CDR3-expressing cells (“distinct CDR3s”, those cells sharing a unique CDR3 sequence) and the numbers of each distinct CDR3 present in a blood or tissue sample from an individual may be produced for an individual patient. The patient's immunoprofile is compared to the combined immunoprofiles of a group of patients who have been diagnosed with a particular disease (a disease library, stored in a database). This can be done for a series of disease libraries, and shown in FIG. 4.

Millions of possible combinations are possible for the public library, the immune systems of most of those individuals generally exhibiting increased diversity over that of a group of individuals who have been diagnosed with a specific disease. Therefore, the inventors determined that an accurate assessment and comparison for the method of the invention would be facilitated by the step of preparing sub-libraries by randomly sampling/selecting from the lists of distinct CDR3s and their numbers in the public library. The number of distinct CDR3 s, represented by unique peptide sequence of CDR3 fragments, should be approximately equal to the number of distinct CDR3s identified in the disease library, or an average calculated from more than one disease library. Producing a significant number of sub-frames, such as, for example, 1000 or more sub-frames, produced by randomly sampling from the public library, increases the presence of a variety of distinct CDR3s and produces a result that is statistically significant effective for identifying and characterizing an individual patient's immunoprofile as normal (“healthy”) or characterized by the presence of a type and number of cells that have been associated with a particular disease.

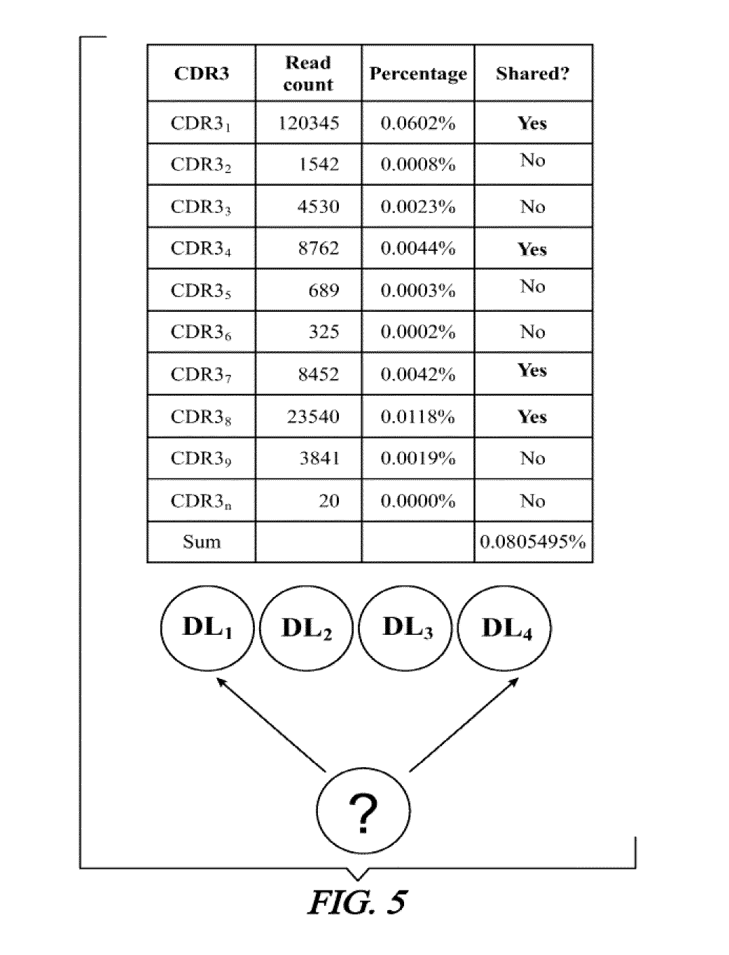

In the method of the invention, a patient supplies a clinical sample comprising, for example, blood or tissue, from which distinct CDR3s are semi-quantitatively amplified and sequenced. This provides the identity and the relative abundance of each CDR3 for all distinct CDR3s. This information may be entered into a program which accesses a database containing at least one public library and one or more disease libraries. Software used for data entry and/or analysis may be accessed via internet access to the database, or may be located on an individual personal computer, with internet access to the sequence information in the database. Comparisons are obtained between the individual immunoprofile and the various libraries and sub-libraries, and results are generated as generally illustrated in FIG. 4 and FIG. 5, where specific CDR3 sequences are detected, the numbers of those distinct CDR3 sequences detected are counted, and a determination is made as to whether or not that specific distinct CDR3 is present in both the individual's immunoprofile and a specific library (i.e., that specific distinct CDR3 is “shared” between the individual and the library). The percentages representing numbers of those CDR3s that are determined to be shared are added together to produce a sum comprising the fraction of the total that comprises CDR3s in the individual's immunoprofile shared between the individual's immunoprofile and the specific library (i.e., a “sharing index”). From the results obtained for the sub-libraries, a P-value is calculated as the probability that a random percentage would be greater than or equal to the percentage noted for a particular disease library, and a significant result is noted when the fraction of times the sampling sharing indices exceeds the original sharing index for a particular library is less than 0.01, for instance, if that sharing index represents the relationship between the individual's immunoprofile and a disease library, the individual may then be informed of the likelihood that the individual/patient has the disease represented by the specific disease library. If P-values computed against all disease libraries is greater than 0.01, the individual's report may indicate that the immune profile looks normal and the disease state has not been detected.

As sequence data is compiled and stored in one or more databases for multiple populations of individuals, it may additionally be possible to associate certain sharing indexes with libraries representing populations with pre-conditions predispositions to certain diseases. The immune system is both proactive and reactive, and changes in the immune system, reflected in the immunoprofile, may provide the first—and sometimes the only—signal that a predisposition, a precondition, or even an established disease is present. The inventors have utilized the method to demonstrate that certain types of cancers, inflammatory bowel disease, and certain viral infections may be detected by determining the sharing index between a patient and an established disease library, obtained by sequencing CDR3s using the ARM-PCR method to produce a subset of the immunorepertoire representing the CDR3s present.

The results are even more reliable when a filter is applied to the sequence data. For example, the inventors have developed a “SMART” filter for the sequence data that aids in the generation of significantly more reliable results. This is described further in the Examples.

By way of further explanation, the following example may be illustrative of the methods of the invention. Blood samples may be taken from children prior to administration of any vaccines, those blood samples for each child establishing a “baseline” from which future samples may be evaluated. For each child, the future samples may be utilized to determine whether there has been an exposure to an agent which has expanded a population of cells known to be correlated with a disease, and this may serve as a “marker” for the risk of development of the disease in the future. Individuals so identified may then be more closely monitored so that early detection is possible, and any available treatment options may be provided at an earlier stage in the disease process.

By means of providing another example, blood samples may be taken from children prior to administration of any vaccines, those blood samples from each child establishing a “baseline” from which future samples may be evaluated. For each child and for the entire population of children in the study, those baselines may be compared to the results of RNA sequencing of T and B cells using target-specific primers to amplify antibody and T-cell receptor, after vaccine administration. The comparison may further involve the evaluation of data regarding symptoms, diagnosed diseases, and other information associated for each individual with the corresponding antibody, and T-cell receptor sequences. If a relationship exists between the administration of a vaccine and the development of a particular disease, individuals who exhibit symptoms of that disease may also share a corresponding antibody or T-cell receptor, for example, or a set of corresponding antibodies or T-cell receptors.

The method of the invention may be especially useful for identifying commonalities between individuals with autoimmune diseases, for example, and may provide epidemiological data that will better describe the correlation between infectious and environmental factors and diseases such as heart disease, atherosclerosis, diabetes, and cancer—providing “biomarkers” that signal either the presence of a disease, or the tendency to develop disease.

The method may also be useful for development passive immunity therapies. For example, following exposure to an infectious agent, certain antibody-producing B cells anchor T cells are expanded. The method of the invention enables the identification of protective antibodies, for example, and those antibodies may be utilized to provide passive immunity therapies in situations where such therapy is needed.

The method of the invention may also provide the ability to accomplish targeted removal of cells with undesirable rearrangements, the method providing a means by which such cells rearrangements may be identified.

The inventor has identified and developed target-specific primers for use in the method of the invention. T-cell-specific primers are shown in Table 1, and antibody-specific primers are shown in Table 2. An additional embodiment of the invention is a method of using any one or a combination of primers of Table 1 or Table 2, to amplify RNA from a blood sample, and more particularly to identify antibodies, T-cell receptors, and HLA molecules within a population of cells.

Arm-PCR or tem-PCR may be used to amplify genes coding for the immunoglobulin superfamily molecules in am amplification method described previously by the inventor (Han et al, 2006, Simultaneous Amplification and Identification of 25 Human Papillomavirus Types with Templex Technology, J. Clin. Micro. 44(11), 4157-4162). In a tem-PCR reaction, nested gene-specific primers are designed to enrich the targets during initial PCR cycling. Later universal “Super” primers are used to amplify all targets. Primers are designated as Fₒ (forward out), Fᵢ (forward in), Rᵢ (reverse in), Rₒ (reverse out), FS (forward super primer) and RS (reverse super primer), with super primers being common to a variety of the molecules due to the addition of a binding site for those primers at the end of a target-specific primer. The gene-specific primers (Fₒ, Fᵢ, Rᵢ and Rₒ) are used at extremely low concentrations. Different primers are involved in the tem-PCR process at each of the three major stages. First, at the “enrichment” stage, low-concentration gene-specific primers are given enough time to find the templates. For each intended target, depending on which primers are used, four possible products may be generated Fₒ/Rₒ, F/Rₒ, F/Rᵢ, and Fₒ/Rᵢ. The enrichment stage is typically carried out for 10 cycles. In the second, or “tagging” stage, the annealing temperature is raised to 72° C., and only the long 40-nucleotide inside primers (Fᵢ and Rᵢ) will work. After 10 cycles of this tagging stage, all PCR products are “tagged” with the universal super primer sequences. Then, at the third “amplification” stage, high-concentration super primers work efficiently to amplify all targets and label the PCR products with biotin during the process. Specific probes may be covalently linked with Luminex color-mated beads.

To amplify the genes coding for immunoglobulin superfamily molecules, the inventor designed nested primers based on sequence information in the public domain. For studying B and T cell VDJ rearrangement, the inventor designed primers to amplify rearranged and expressed RNAs. Generally, a pair of nested forward primers is designed from the V genes and a set of reverse nested primers are designed from the J or C genes. The average amplicon size is 250-350 bp. For the igHV genes, for example, there are 123 genes that can be classified into 7 different families, and the present primers are designed to be family specific. However, if sequencing the amplified cDNA sequences, there are enough sequence diversities to allow further differentiation among the gene within the same family. For the MHC gene locus, the intent is to amplify genomic DNA.

### EXAMPLES

### Calculation of Sharing Index

Assuming that S is a subject's immunoprofile (IP), which is represented by N unique CDR3 sequences CDR3₁, CDR3₂, . . . CDR3ₙ, each CDR3 has its own frequency s₁, s₂, . . . sₙ.

D is a disease library, which is the sum of a certain number of patients' immunoprofile with M unique CDR3s. All patients in the disease library were diagnosed to have the same disease.

P is a public library, which is the sum of a large number of control's immunoprofile.

The Sharing Index is defined as the sum of sₓ, s_{y}, . . . x_{z}, where CDR3ₓ, CDR3_{y}, . . . CDR3_{z} are shared in the subject's immunoprofile and a library. Note that sₓ, s_{y}, . . . s_{z} is the frequency of CDR3s in the subject's immunoprofile, not in the library.

Assuming that there are always more unique CDR3s in a public library (P) than in a disease library (D), M unique CDR3s in the public library are randomly selected and used to create a sub-library P1 and the sharing index (SIₚ₁) between the subject and the sub-library computed according to above formula. The sampling procedure is repeated 1000 or more times and 1000 or more SIₚₓ are computed.

The sharing index SI_{d} between the subject and the disease library are computed in the same manner. The P-value is defined as the fraction of all SIs (SIₚ₁, SIₚ₂, . . . SIₚₓ, SI_{d}. (Note that SI_{d} is included), which is equal to or greater than SI_{d}. Note that when sampling CDR3s in the public library, CDR3s found in x control's immunoprofiles are given x times of chances to be sampled.

### Amplification of T or Rearrangement Sites

All oligos were resuspended using 1× TE. All oligos except 454A and 454B were resuspended to a concentration of 100 pmol/μL. 454A and 454B were resuspended to a concentration of 1000 pmol/μL. 454A and 454B are functionally the same as the communal primers described previously, the different sequences were used for follow up high throughput sequencing procedures.

Three different primer mixes were made. An Alpha Delta primer mix included 82 primers (all of TRAV-C+TRDV-C), a Beta Gamma primer mix included 79 primers (all of TRBVC and TRGV-C) and a B cell primer mix that included a total of 70 primers. Fₒ, Fᵢ, and Rᵢ primers were at a concentration of 1 pmol/μL. Rₒ primers were at a concentration of 5 pmol/μL. 454A and 454B were at a concentration of 30 pmol/μL.

Three different RNA samples were ordered from ALLCELLS (www.allcells.com). All samples were diluted down to a final concentration of 4 ng/uL. The samples ordered were:

| Cell type: | Source: |
|---|---|
| ALL-PB-MNC | A patient with acute lymphoblastic leukemia |
| NPB-Pan T Cells | Normal T cells |
| NPB-B Cells | Normal B cells |

RT-PCR was performed using a Qiagen One-Step RT-PCR kit. Each sample contained the following:

10 μL of Qiagen Buffer

2 μL of DNTP's

2 μL of Enzyme

23.5 μL of dH₂O

10 μL of the appropriate primer mix

2.5 μL of the appropriate template (10 ng of RNA total)

The samples were run using the following cycling conditions:
50° C. for 30 minutes
95° C. for 15 minutes
94° C. for 30 seconds

15 cycles of
55° C. for 1 minute
17° C. for 1 minute
94° C. for 15 seconds

6 cycles of
70° C. for 1 minute 30 seconds
94° C. for 15 seconds

30 cycles of
55° C. for 15 seconds
72° C. for 15 seconds
72° C. for 3 minutes
4° C. Hold

The order of samples placed in the gel shown in FIG. 1a was: (1) Ladder (500 bp being the largest working down in steps of 20 bp, the middle bright band in FIG. 1a is 200 bp); (2) α+δ primer mix with 10 ng Pan T Cells Template; (3) β+γ primer mix with 10 ng Pan T Cells Template; (4) B Cell primer mix with 10 ng B Cells Template; (5) B Cell primer mix with 10 ng ALL Cells Template; (6) α+δ primer mix with 10 ng ALL Cells Template; (7) β+γ primer mix with 10 ng ALL Cells Template; 8. α+δ primer mix blank; (9) β+γ primer mix blank; (10) B Cell primer mix blank; (11) Running buffer blank. These samples were run on a pre-cast ClearPAGE® SDS 10% gel using 1× ClearPAGE® DNA native running buffer.

The initial experiment showed that a smear is generated from PCR reactions where templates were included. The smears indicate different sizes of PCR products were generated that represented a mixture of different VDJ rearrangements. There is some background amplification from the B cell reaction. Further improvement on that primer mix was required to clean up the reaction.

To determine whether the PCR products indeed include different VDJ rearrangements, it was necessary to isolate and sequence the single clones. Instead of using the routine cloning procedures, the inventor used a different strategy. PCR products generated from the Alpha Delta mix and the Beta Gamma mix (lanes 2 and 3 in FIG. 1a) were diluted 1:1000 and a 2 μl aliquot used as PCR template in the following reaction. Then, instead of using a mixture of primers that targeting the entire repertoire, one pair of specific Fi and Ri primers were used (5 pmol each) to amplify only one specific PCR product. The following cycling conditions were used to amplify the samples:
95° C. for 5 minutes

30 cycles of
94° C. for 30 seconds
72° C. for 1 minute
72° C. for 3 minutes
4° C. hold

A Qiagen PCR kit was used to amplify the products. The Master Mix used for the PCR contained the following:

| | |
|---|---|
| Per Reaction | Master Mix x 12 |

| | | | |
|---|---|---|---|
| 10x PCR Buffer | 5 | μL | 60 μL |
| dNTP | 1 | μL | 12 μL |
| HotStartTaq Plus | 0.25 | μL | 3 μL |
| H₂O | 39.75 | μL | 477 μL |

The photograph of the gel in FIG. 1b shows the PCR products of the following reactions: (1) Ladder; (2) TRAV1Fi+TRACRi with alpha delta Pan T PCR product; (3) TRAV2Fi+TRACRi with alpha delta Pan T PCR product; (4) TRAV3Fᵢ+TRACRᵢ with alpha delta Pan T PCR product; (5) TRAV4Fᵢ+TRACRᵢ with alpha delta Pan T PCR product; (6) TRAV5Fᵢ+TRACRᵢ with alpha delta Pan I PCR product; (7) TRAV1Fᵢ+TRACRᵢ with alpha delta Pan T PCR product; (8) TRAV2Fᵢ+TRACRᵢ with alpha delta Pan T PCR product; (9) TRAV3Fᵢ+TRACRᵢwith alpha delta Pan I PCR product; (10) TRAV4Fᵢ+TRACRᵢ with alpha delta Pan T PCR product; (11) TRAV5Fᵢ+TRACR with alpha delta Pan T PCR product; (12) PCR Blank. Primers listed as Fᵢ are “forward inner” primers and primers listed as Fₒ are “forward outer” primers, with Rᵢ and Rₒ indicating “reverse inner” and “reverse outer” primers, respectively.

As illustrated by FIG. 1b, a single PCR product was generated from each reaction. Different se bands were generated from different reactions. This PCR cloning approach is successful for two major reasons—(1) The PCR templates used in this reaction were diluted PCR products (1:1000) of previous reactions that used primer mixes to amplify all possible VDJ rearrangements (for example, a primer mix was used that included total of 82 primers to amplify T cell receptor Alpha and Delta genes) and (2) Only one pair of PCR primer, targeting a specific V gene, are used in each reaction during this “cloning” experiment. Some of these products were gel purified and sequenced. The following are example sequences obtained from the protocol described above. In every case, a single clone was obtained, and a specific T cell receptor V gene that matched the Fi primer was identified.

TRAV1 template + 454A as sequencing primer:
(SEQ ID NO. 1)
NNNNNNNNNNCNTANTCGGTCTAAGGGTACNGNTACCTCCTTTTGAAGGA
CCTCCAGATGAAAGACTCTGCCTCTTACCTCTGTGCTGTGAGAGATANCA
ACNATCACTTAATCTTGGGCGCTGGGAGCAGACTAATTATAATGCCAGAT
ATCCACAACCCTGACCCTGCCGCGTACCAGCTGAAAGACTATGAACAGGA
TGGGGAGGCAGNAGNAGNAG
TRAV1 template + 454A as sequencing primer:
(SEQ ID NO. 2)
NNNNNNNNNNGNANGNNGAGGGTTCTGGATATTTGGTTTNACAATTAGCT
TGGTCCCTGCTCCAAGATTAATTTGTAGTTGCTATCCCTCAGAGCAGAGA
GGTAAGAGGAAGAGTATTTCTTCTGGAGCTCCTTCAACAGGAGGAAACTG
TACCCTTTATACCTACTAAGGAATGAAGA
TRAV2 template + 454A as sequencing primer:
(SEQ ID NO. 3)
NNNNNNNNNNNNTNNCGGTTCTCTTNNTCGCTGCTCATCCTCCAGGTGCG
GGAGGCAGATGCTGCTGTTTACTACTGTGCTGTGNANNANGGCANNGACA
ACAACCTCNTCTTTGGTGGAGGNACCCTACTNNTGGTTATNCCNAATANC
CANAACCCTGACCCTGCCGAGNAGCAGCANAAAAACTNNNAGGGGGGTGG
AGAAGNANNNNN
TRAV3 template + 454A as sequencing primer:
(SEQ ID NO. 4)
NNNNNNNNNNNNNNGGNNNGGNAGCTATGGCTTTGAAGCTGAATTTAACA
AGAGCCAAACCTCCTTCCACCTGAAGAAACCATCTGCCCTTGTGAGCGAC
TCCGCTTTGTACTTCTGTGCTGTGAGAGACATCAACGCTGCCGGCAACAA
CCTAACTTTTGGAGGAAGAACCATGGTGCTAGTTAAACCAAATATCCATA
ACCCTGACGCTGCCGTGTACCAGCTGAAAGACTCTGAGGGGGCTGGAGAG
GNAGGNG
TRAV4 template + 454A as sequencing primer
(SEQ ID NO. 5)
NNNNNANNGGNNNNNGTTTATCCCTGCCGACAGAAAGTCCAGCACTCTGA
GCCTGCCCCGGGTTTCCCTGAGCGACACTGCTGTGTACTACTGCCTCGTG
GGTGACCGGTCTGGAAACAGCGATGAAATTTTCATCTTAGGAAGAAGAAC
GCTTCTAGTCATCCANCCCAACATCCACAACCCTGCCGCGGAGNAGCACC
AGAAAAAAGATGATGAGGGGGANGNAGNAGNANNNN
TRAV5 template + 454A as sequencing primer:
(SEQ ID NO. 6)
NNNNNNNNNNNNNNNNTCNCTGNTCTATTGAATAAAAAGGATAAACATCT
GTCTCTGCGCATTGCAGACACCCAGACTGGGGACTCAGCTATCTACTTCT
GTGCAGAGAGCCCCGGTGGCGGCAGCAACTTCTTCTTTGGTGGAGGAGCA
NTACTACTAGTCGTTCTACATANCCACAACCATGATNCCGCCGAGTACNT
GCTGAAAAAATATGATGAGGATGGAGAAGAAGNAGCATNAN
TRBV19Fi template + 454A as sequencing primer:
(SEQ ID NO. 7)
NNNNNNNNCTGAGGGTANNCGTCTCTCGGGAGAAGAAGGAATCCTTTCCT
CTCACTGTGACATCGGCCCAAAAGAACCCGACAGCTTTCTATCTCTGTGC
CAGTAGTATGGGGGGGGGGGCCTACAATGAGNACGGCGGCGGGGGAGGGA
CNNTGCTCGTCGTGGAGGAGGACATGAAGGTCTTGCCCGCNNCNGAGGAA
GNTGNANANGAACCATAAAAATGCGCTGGCTGAANNN
TR8V20Fi template + 454A as sequencing primer:
(SEQ ID NO. 8)
NNNNNNNNNNNGCTCNNNNNNCNCATACGAGCAAGGCGTCGAGAAGGACA
AGTTTCTCACAACCATGCAAGCCTGACCTTGTCCACTCTGACAGTGACCA
GTGCCCATCCTGAAGACAGCAGCTTCTACATCTGCAGTGCTAGAGGGGGG
GGGGGGGACGACTACTACTACTTCGGCGGGGGGGGCATGCTGATCGTGGA
GGAGGAGGACATGNAGCTCCTCCGCGCCGCCGAGGTTGTTGTGTNTNNAN
CATCATACTGNTGGTGGAGNAGNAGNAGCN
TRBV21Fi template + 454A as sequencing primer:
(SEQ ID NO. 9)
NNNNNNNNNNNNNNNGNNNNNNNNNNNTACTTTCNGAATGAAGAACTTAT
TCAGAAAGCAGAAATAATCAATGAGCGATTTTTAGCCCAATGCTCCAAAA
ACTCATCCTGTACCTTGGAGTTCCAGTCCACGGAGTCAGGGGACACAGCA
CTGTATTTCTGTGCCAGCAGCA
TRBV23Fi template + 454A as sequencing primer:
(SEQ ID NO. 10)
NNNGNNNNNNNANNGGANANGCACAAGAAGCGATTCTCATCTCAATGCCC
CAAGAACGCACCCTGCAGCCTGGCAATCCTGTCCTCAGAACCGGGAGACA
CGGCACTGTATCTCTGCGCCAGCAGTCAATCGGGGGGGGGGGGGAGGGCC
GTCCGCAGCGGGGGGGGGGGGGGCCGGGGGACGGTCCCAAAGAGAAAGAA
AACCTGCCCCCCGCGCTCGGGCGGTGTGATTGAGCGAAACAGACAGGAAG
GNAAGNAAAAAANNNNANCNNCNCTCNN
TRBV24Fi template + 454A as sequencing primer:
(SEQ ID NO. 11)
NNNNNNNNGNNANNNTCTGATGGANACAGTGTCTCTCGACAGGCACAGGC
TAAATTCTCCCTGTGCCCTAGAGTCTGCCATCCCCAACCAGACAGCTCTT
TACTTCTGTGCCACCAGTGANGCGGGGGGCGGGGACCACTACTTCGGGGG
GGGGAGGCGGACCAGGGTGCTGGTCGACGAGAAAAAGGAGCTCCCCCCCG
CCGCCGCTGTGGTTGTTGCTTCATAATAATCAGGNNGGNGAGGNAGNAGN
AANN

To investigate the impact of artifacts on the overall repertoire analysis of the TCRβ transcriptome, the inventors conducted control experiments using chemically synthesized TCRβ CDR3 templates. For this, the inventors chemically synthesized four distinct clones, clonally purified each clone, and prepared different mixes of the four constucts as templates for amplicon rescue multiplex (ARM)-PCR. Two different reaction mixtures were subjected to two independent ARM-PCR reactions, and the pooled PCR products were sequenced at a length of 100 bp from both ends using the Illimuna HiSeq2000®. The inventors first joined together paired-end reads through overlapping alignment with a modified Needleman-Wunsch algorithm, and then mapped the merged sequences to germline V, D and J reference sequences.

Without cleaning, the inventors obtained a total of 5,729,613 sequences from template mix I that could be mapped to TCRβ V, D and J segments. Surprisingly, the sequence reads purportedly represented a total of 36,439 unique CDR3 variants. Therefore, given that only four distinct CDR3 variants were present in the template mixtures, virtually all of the identified CDR3 variants must be non-authentic. Similar results were obtained for the second template mix, in which a total of 9,131,681 VDJ-mapped sequences were identified that mimicked the existence of 50,354 unique TCRβ CDR3 variants. The inventors' independent sequencing experiments show that only a few distinct CDR3 template variants can create artifactual repertoire diversities that far outweigh the real template diversity, and thus the inventors set out to eliminate these artifacts.

The quality of 3′ end Illumina sequencing reads is generally considered to be low. In the context of repertoire sequencing, this is troublesome because PCR primers need to be positioned distal enough from the hypervariable V(D)J junctions to avoid negative effects due to primer-template mismatching. As a consequence, the CDR3 segments of interest are generally “shifted” closer to the 3′ end of the sequencing reads, the region with increased sequencing error rates. Another technical issue that deserves attention is the observation that sequencing errors are context-specific end consequently strand-specific. Therefore, it is realistic to assume that the probability that a sequencing error a forward read coincides with that in the corresponding reverse read is rare.

Considering this, the inventors devised a paired-end strategy that affords double-strand sequencing of complete TCR CDR3 segments on the basis of the Illumina® technology. In this approach, forward and reverse sequencing primers are positioned at the framework region 3 and at the TCR J region or the 5′ end of the C region, respectively. Taking into account the average length of Illumina sequence reads (currently 100-150 bp) this design enables the complete sequencing of both strands that define a CDR3 segment. In a second step, the forward and reverse reads are then analyzed for sequence mismatches and CDR3 sequences that exhibit non-identity of both strands are eliminated using a newly developed paired-end filtering algorithm.

Applying this sequencing error filter to the 5,729,613 CDR3 sequences obtained for template mix I, the inventors identified a total of 2,751,131 (48%) CDR3 sequences that contained conflicting sequence information on their opposite strands. Discarding of these sequences resulted in the elimination of 35,455 (97.2%) distinct artifactual CDR3 variants. Consistent with this, the paired-end filter removed 4,308,020 (47%) CDR3 sequences from template mix II, leading to the elimination of 49,063 (97.4%) artifectual CDR3 variants. A total of 973 and 1271 unique CDR3 variants, respectively, passed through the filter. These results indicate that paired-end sequencing and filtering reduces the total number of non-authentic unique CDR3 sequences by almost two orders of magnitude.

Detailed analysis of the frequency distribution of the non-authentic CDR3 variants after the sequencing error filter revealed that in both mixtures approximately 50% of all artifacts were single-copy sequences. About 10% of these artifactual CDR3s displayed >100 copy numbers and accounted for >80% of all artifactual CDR3 variants. Given that variable TCR genes do not undergo somatic hypermutation, the inventors developed a reference algorithm that identifies and removes CDR3 sequence reads that display nucleotide mismatches relative to the mapped germline V, D and J reference sequences, as these must be artifacts generated at the level of PCR amplification or sequencing.

Applying this filtering algorithm to the “paired-end filtered” sequences of template mix I, a total of 29,804 sequences, which corresponded to 609 unique CDR3 variants, were removed. For template mix II, 54,516 artifactual sequences (831 unique CDR3 variants) were identified. Thus, the use of the reference sequence filter leads to a 60% reduction of non-authentic distinct CDR3 sequences. The reference filter is ineffective at the V-J and D-J junctions because the randomly added nucleotides in these regions during somatic recombination cannot be mapped. Therefore, the inventors implemented a PCR filter after computational simulation experiments to better understand four variables: the impact of the initial template number, the replication efficiency of each cycle, the cycle number (n), and the DNA polymerase error rate (μ) on the total end-point error rate. In contrast, the inventors noted that the PCR polymerase error rate has a pronounced effect on the number of accumulated errors

In the inventors' control sequencing experiments, PCR amplification was performed with 15 cycles and 45 cycles in the first and second reaction, using Taq polymerase. To simulate error accumulation during the ARM-PCR reactions more realistically, the PCR efficiency was set to decreased 5% per cycle for the first 25 cycles and 10% per cycle for the remaining cycles. The PCR efficiency was reset to 1.0 for each fresh PCR reaction. Furthermore, the inventors allowed mutation at the second position. Published substitution error rates for Taq enzyme, expressed as errors per bp per cycle, range from 0.023×10⁻⁴ to 2.1×10⁻⁴. In the simulation experiments, the substitution error rate was set at 2.7×10⁻⁵, and the insertion-deletion (indel) error rate was set as 1.0×10⁻⁶. Taq polymerase is known to have a much higher insertion-and-deletion (indel) mutation rate in homopolymeric region of templates. For a homopolymeric region, indel mutation in any position of this region generates identical pattern. Therefore, the indel error rate in a homopolymeric region was set n×μ, where n is the length of the homopolymeric region and μ is 1.0×10⁻⁶.

Because the impact of the initial template number and the PCR efficiency on the endpoint error rate is small, it should be safe to apply the same end-point error rate estimated from the simulation experiments to molecules with different initial number and different replication efficiencies in a multiplex PCR reaction. The cutoff error rates (μ) were empirically set as error rates at the 9999th 10000-quantiles point for each category. For two similar CDR3 sequences, A and B, of frequency NA and NB (NA>>NB) that differ in less than three positions, if NA*μ≧NB, where μ is the corresponding cutoff error rate, CDR3 sequence B will be excluded. Applying this filtering algorithm to the “reference filtered” sequences of template mix I, a total of 22,369 sequences, which corresponded to 281 unique CDR3 variants, were removed. For template mix II, 39,920 artifactual sequences (348 unique CDR3 variants) were identified (Table 1). Thus, the use of the PCR amplification error filter leads to a further reduction of non-authentic distinct CDR3 sequences by around 80%.

In the pool of sequences that had passed through the above filters, the inventors identified several high-abundance CDR3 variants, which differed from their most similar input template sequences at multiple positions. Because the occurrence of PCR substitution and/or indel mutation at multiple positions of CDR3 fragments is extremely rare according to simulation experiments, those CDR3 variants must arise from other source of artifacts. Intriguingly, the inventors noted that some of these sequences were composed of the fragments of two distinct input templates and exhibited clear breakpoints, which identified them as chimeras. Chimeric sequences are PCR artifacts that arise from incomplete primer extension or template switching during PCR and form mosaic-like structures. In light of this unexpected PCR artifact, the inventors developed a computational “mosaic filter.” Using this filtering algorithm, the inventors identified a total of 17 and 15 chimeric sequences in template mixtures I and II respectively. Of note, some of these CDR3 chimeras displayed sequence copy numbers >1000, indicating that the inventors algorithm for the filter is capable of identifying high-abundance chimeric CDR3 sequences.

Application of the filtering algorithms resulted in the elimination of 99.8% of the non-authentic unique CDR3 sequences generated by high-throughput sequencing of only four defined TCR CDR3 templates. Only 62 and 73 artifactual CDR3 sequences, respectively, passed through all filters. Among these, the two most abundant CDR3 sequences were identical in both mixing experiments. Most likely they represent chimeric artifacts which escaped filtering because of a single nucleotide substitution located exactly at the breakpoint. Among the remaining erroneous CDR3, 85% (n=53) and 75% (n=55) were single reads, respectively. To eliminate this minor fraction of artifacts, the inventors propose that high-stringency data analysis of TCR immune repertoires should include an additional filter that removes single copy CDR3 reads (frequency threshold filter).

TABLE 1

| | Primer | | SEQ ID | | SEQ ID |
|---|---|---|---|---|---|
| Locus | Name | Sequence | NO. | Sequence | NO. |
| TRAV-C | TRAV1Fo | TGCACGTACC | 12 | TGCACGTACCA | 12 |
| | | AGACATCTGG | | GACACTGG | |
| | TRAV1Fi | AGGTCCCTTTT | 13 | GCCTCCCTCGC | 14 |
| | | TCTTCATTCC | | GCCATCAGAGG | |
| | | | | TCGTTTTTCTTC | |
| | | | | ATTCC | |
| | TRAV2Fo | TCTGTAATCA | 15 | TCTGTAATCACT | 15 |
| | | CTCTGTGTCC | | CTGTGTCC | |
| | TRAV2Fi | AGGGACGATA | 16 | GCCTCCCTCGC | 17 |
| | | CAACATGACC | | GCCATCAGAGG | |
| | | | | GACGATACAAC | |
| | | | | ATGACC | |
| | TRAV3Fo | CTATTCAGTC | 18 | CTATTCAGTCT | 18 |
| | | TCTGGAAACC | | CTGGAAACC | |
| | TRAV3Fi | ATAGATCACA | 19 | GCCTCCCTCGC | 20 |
| | | GGGGATAACC | | GCCATCAGATA | |
| | | | | CATCAGAGGGG | |
| | | | | ATAACC | |
| | TRAV4Fo | TGTAGGCACA | 21 | TGTAGCCACAA | 21 |
| | | ACAACATTGC | | CAACATTGC | |
| | TRAV4Fi | AAAGTTACAA | 22 | GCCTCCCTCGC | 23 |
| | | ACGAAGTGGC | | GCCATCAGAAA | |
| | | | | GTTACAAACGA | |
| | | | | AGTGGC | |
| | TRAV5Fo | GCACTTACAC | 24 | GCACTTACACA | 24 |
| | | AGACAGCTCC | | GACAGCTCC | |
| | TRAV5Fi | TATGGACATG | 25 | GCCTCCCTCGC | 26 |
| | | AAACAAGACC | | GCCATCAGTAT | |
| | | | | GGACATGAAAC | |
| | | | | AAGACC | |
| | TRAV6Fo | GCAACTATAC | 27 | GCAACTATACA | 27 |
| | | AAACTATTCC | | AACTATTCC | |
| | TRAV6Fi | GTTTTCTTGC | 28 | GCCTCCCTCGC | 29 |
| | | TACTCATACG | | GCCATCAGGTT | |
| | | | | TTCTTGCTACTC | |
| | | | | ATACG | |
| | TRAV7Fo | TGCACGTACT | 30 | TGCACGTACTC | 30 |
| | | CTGTCAGTCG | | TGTCAGTCG | |
| | TRAV7Fi | GGATATGAGA | 31 | GCCTCCCTCGC | 32 |
| | | AGCAGAAAGG | | GCCATCAGGGA | |
| | | | | TATGAGAAGCA | |
| | | | | GAAAGG | |
| | TRAV8Fo | AATCTCTTCT | 33 | AATCTCTTCTG | 33 |
| | | GGTATGTSCA | | GTATGTSCA | |
| | TRAV8Fi | GGYTTTGAGG | 34 | GCCTCCCTCGC | 35 |
| | | CTGAATTTA | | GCCATCAGGGY | |
| | | | | TTTGAGGCTGA | |
| | | | | ATTTA | |
| | TRAV9Fo | GTCCAATATC | 36 | GTCCAATATCC | 36 |
| | | CTGGAGAAG | | TGGAGAAGG | |
| | | G | | | |
| | TRAV9Fi | AACCACTTCT | 37 | GCCTCCCTCGC | 38 |
| | | TTCCACTTGG | | GCCATCAGAAC | |
| | | | | CACTTCTTTCCA | |
| | | | | CTTGG | |
| | TRAV10Fo | AATGCAATTA | 39 | AATGCAATTATA | 39 |
| | | TACAGTGAGC | | CAGTGAGC | |
| | TRAV10Fi | TGAGAACACA | 40 | GCCTCCCTCGC | 41 |
| | | AAGTCGAACG | | GCCATCAGTGA | |
| | | | | GAACACAAAGT | |
| | | | | CGAACG | |
| | TRAV11Fo | TCTTAATTGTA | 42 | TCTTAATTGTAC | 42 |
| | | CTTATCAGG | | TTATGAGG | |
| | TRAV11Fi | TCAATCAAGC | 43 | GCCTCCCTCGC | 44 |
| | | CAGAAGGAG | | GCCATCAGTCA | |
| | | C | | ATCAAGCCAGA | |
| | | | | AGGAGC | |
| | TRAV12Fo | TCAGTGTTCC | 45 | TCAGTGTTCCA | 46 |
| | | AGAGGGAGC | | GAGGGAGCC | |
| | | C | | | |
| | TRAV12Fi | ATGGAAGGTT | 46 | GCCTCCCTCGC | 47 |
| | | TACGCACAG | | GCCATCAGATG | |
| | | | | GAAGGTTTACA | |
| | | | | GCACAG | |
| | TRAV13Fo | ACCCTGAGTG | 48 | ACCCTGAGTGT | 48 |
| | | TCCAGGAGG | | CCAGGAGGG | |
| | | G | | | |
| | TRAV13Fi | TTATAGACAT | 49 | GCCTCCCTCGC | 50 |
| | | TCGTTCAAAT | | GCCATCAGTTA | |
| | | | | TAGACATTCGT | |
| | | | | TCAAAT | |
| | TRAV14Fo | TGGACTGCAC | 51 | TGGACTGCACA | 51 |
| | | ATATGACACC | | TATGACACC | |
| | TRAV14Fi | CAGCAAAATG | 52 | GCCTCCCTCGC | 53 |
| | | CAACAGAAGG | | GCCATCAGCAG | |
| | | | | CAAAATGCAAC | |
| | | | | AGAAGG | |
| | TRAV16Fo | AGCTGAAGTG | 54 | AGCTGAAGTGC | 54 |
| | | CAACTATTCC | | AACTATTCC | |
| | TRAV16Fi | TCTAGAGAGA | 55 | GCCTCCCTCGC | 56 |
| | | GCATCAAAGG | | GCCATCAGTCT | |
| | | | | AGAGAGAGCAT | |
| | | | | CAAAGG | |
| | TRAV17Fo | AATGCCACCA | 57 | AATGCCACCAT | 57 |
| | | TGAACTGCAG | | GAACTGCAG | |
| | TRAV17Fi | GAAAGAGAGA | 58 | GCCTCCCTCGC | 59 |
| | | AACACAGTGG | | GCCATCAGGAA | |
| | | | | AGAGAGAAACA | |
| | | | | CAGTGG | |
| | TRAV18Fo | GCTCTGACAT | 60 | GCTCTGACATT | 60 |
| | | TAAACTGCAC | | AAACTGCAC | |
| | TRAV18Fi | CAGGAGACG | 61 | GCCTCCCTCGC | 62 |
| | | GACAGCAGA | | GCCATCAGCAG | |
| | | GG | | GAGACGGACAG | |
| | | | | CAGAGG | |
| | TRAV19Fo | ATGTGACCTT | 63 | ATGTGACCTTG | 63 |
| | | GGACTGTGTG | | GACTGTGTG | |
| | TRAV19Fi | GAGCAAAATG | 64 | GCCTCCCTCGC | 65 |
| | | AAATAAGTGG | | GCCATCAGGAG | |
| | | | | CAAAATGAAAT | |
| | | | | AAGTGG | |
| | TRAV20Fo | ACTGCAGTTA | 66 | ACTGCAGTTAC | 66 |
| | | CACAGTCAGC | | ACAGTCAGC | |
| | TRAV20Fi | AGAAAGAAAG | 67 | GCCTCCCTCGC | 68 |
| | | GCTAAAAGCC | | GCCATCAGAGA | |
| | | | | AAGAAAGGCTA | |
| | | | | AAAGCC | |
| | TRAV21Fo | ACTGCAGTTT | 69 | ACTGCAGTTTC | 69 |
| | | CACTGATAGC | | ACTGATAGC | |
| | TRAV21Fi | CAAGTGGAAG | 70 | GCCTCCCTCGC | 71 |
| | | ACTTAATGCC | | GCCATCAGCAA | |
| | | | | GTGGAAGACTT | |
| | | | | AATGCC | |
| | TRAV22Fo | GGGAGCCAAT | 72 | GGGAGCCAATT | 72 |
| | | TCCACGCTGC | | CCACGCTGC | |
| | TRAV22Fi | ATGGAAGATT | 73 | GCCTCCCTCGC | 74 |
| | | AAGCGCCAC | | GCCATCAGATG | |
| | | G | | GAAGATTAAGC | |
| | | | | GCCACG | |
| | TRAV23Fo | ATTTCAATTAT | 75 | ATTTCAATTATA | 75 |
| | | AAACTGTGC | | AACTGTGC | |
| | TRAV23Fi | AAGGAAGATT | 76 | GCCTCCCTCGC | 77 |
| | | CACAATCTCC | | GCCATCAGAAG | |
| | | | | GAAGATTCACA | |
| | | | | ATCTCC | |
| | TRAV24Fo | GCACCAATTT | 78 | GCACCAATTTC | 78 |
| | | CACCTGCAGC | | ACCTGCAGC | |
| | TRAV24Fi | AGGACGAATA | 79 | GCCTCCCTCGC | 80 |
| | | AGTGCCACTC | | GCCATCAGAGG | |
| | | | | ACGAATAAGTG | |
| | | | | CCACTC | |
| | TRAV25Fo | TCACCACGTA | 81 | TCACCACGTAC | 81 |
| | | CTGCAATTCC | | TGCAATTCC | |
| | TRAV25Fi | AGACTGACAT | 82 | GCCTCCCTCGC | 83 |
| | | TTCAGTTTGG | | GCCATCAGAGA | |
| | | | | CTGACATTTCA | |
| | | | | GTTTGG | |
| | TRAV26Fo | TCACAGATT | 84 | TCGACAGATTC | 84 |
| | | CMCTCCCAG | | MCTCCCAGG | |
| | | G | | | |
| | TRAV26Fi | GTCCAGYACC | 85 | GCCTCCCTCGC | 86 |
| | | TTGATCCTGC | | GCCATCAGGTC | |
| | | | | CAGYACCTTGA | |
| | | | | TCCTGC | |
| | TRAV27Fo | CCTCAAGTGT | 87 | CCTCAAGTGTT | 87 |
| | | TTTTTCCAGC | | TTTTCCAGC | |
| | TRAV27Fi | GTGACAGTAG | 88 | GCCTCCCTCGC | 89 |
| | | TTACGGGTGG | | GCCATCAGGTG | |
| | | | | AGAGTAGTTAC | |
| | | | | GGGTGG | |
| | TRAV29Fo | CAGCATGTTT | 90 | CAGCATGTTTG | 90 |
| | | GATTATTTCC | | ATTATTTCC | |
| | TRAV29Fi | ATCTATAAGT | 91 | GCCTCCCTCGC | 92 |
| | | TCCATTAAGG | | GCCATCAGATC | |
| | | | | TATAAGTTCCAT | |
| | | | | TAAGG | |
| | TRAV30Fo | CTCCAAGGCT | 93 | CTCCAAGGCTT | 93 |
| | | TTATATTCTG | | TATATTCTG | |
| | TRAV30Fi | ATGATATTAC | 94 | GCCTCCCTCGC | 95 |
| | | TGAAGGGTG | | GCCATCAGATG | |
| | | G | | ATATTACTGAA | |
| | | | | GGGTGG | |
| | TRAV34Fo | ACTGCACGTC | 96 | ACTCCACGTCA | 96 |
| | | ATCAAAGACG | | TCAAAGACG | |
| | TRAV34Fi | TTGATGATGC | 97 | GCCTCCCTCGC | 98 |
| | | TACAGAAAGG | | GCCATCAGTTG | |
| | | | | ATGATGCTACA | |
| | | | | GAAAGG | |
| | TRAV35Fo | TGAACTGCAC | 99 | TGAACTGCACT | 99 |
| | | TTCTTCAAGC | | TCTTCAAGC | |
| | TRAV35Fi | CTTGATAGCC | 100 | GCCTCCCTCGC | 101 |
| | | TTATATAAGG | | GCCATCAGCTT | |
| | | | | GATAGCCTTAT | |
| | | | | ATAAGG | |
| | TRAV36Fo | TCAATTGCAG | 102 | TCAATTGCAGT | 102 |
| | | TTATGAAGTG | | TATGAAGTG | |
| | TRAV36Fi | TTTATGCTAA | 103 | GCCTCCCTCGC | 104 |
| | | CTTCAAGTGG | | GCCATCAGTTT | |
| | | | | ATGCTAACTTC | |
| | | | | AAGTGG | |
| | TRAV38Fo | GCACATATGA | 105 | GCACATATGAC | 105 |
| | | CACCAGTGAG | | ACCAGTGAG | |
| | TRAV38Fi | TCGCCAAGAA | 106 | GCCTCCCTCGC | 107 |
| | | GCTTATAAGC | | GGCATCAGTCG | |
| | | | | CCAAGAAGCTT | |
| | | | | ATAAGC | |
| | TRAV39Fo | TCTACTGCAA | 108 | TCTACTGCAATT | 108 |
| | | TTATTCAACC | | ATTCAACC | |
| | TRAV39Fi | CAGGAGGGA | 109 | GCCTCCCTCGC | 110 |
| | | CGATTAATGG | | GCCATCAGCAG | |
| | | C | | GAGGGACGATT | |
| | | | | AATGGC | |
| | TRAV40Fo | TGAACTGCAC | 111 | TGAACTGCACA | 111 |
| | | ATACACATCC | | TACACATCC | |
| | TRAV40Fi | ACAGCAAAAA | 112 | GCCTCCCTCGC | 113 |
| | | CTTCGGAGGC | | CCATCAGACA | |
| | | | | GCAAAAACTTC | |
| | | | | GGAGGC | |
| | TRAV41Fo | AACTGCAGTT | 114 | AACTGCAGTTA | 114 |
| | | ACTCGGTAGG | | CTCGGTAGG | |
| | TRAV41Fi | AAGCATGGAA | 115 | GCCTCCCTCGC | 116 |
| | | GATTAATTGC | | GCCATCAGAAG | |
| | | | | CATGGAAGATT | |
| | | | | AATTGC | |
| | TRACRo | GCAGACAGAC | 117 | GCAGACAGACT | 117 |
| | | TTGTCACTGG | | TGTCACTGG | |
| | TRACRi | AGTCTCTCAG | 118 | GCCTTGCCAGC | 119 |
| | | CTGGTACACG | | CCGCTCAGAGT | |
| | | | | CTCTCAGCTGG | |
| | | | | TACACG | |
| TRBV-C | TRBV1Fo | AATGAAACGT | 120 | AATGAAACGT | 120 |
| | | GAGCATCTGG | | AGCATCTGG | |
| | TRBV1Fi | CATTGAAAAC | 121 | GCCTCCCTCGC | 122 |
| | | AAGACTGTGC | | GCCATCAGCAT | |
| | | | | TGAAAACAAGA | |
| | | | | CTGTGC | |
| | TRBV2Fo | GTGTCCCCAT | 123 | GTGTCCCCATC | 123 |
| | | CTCTAATCAC | | TCTAATCAC | |
| | TRVV2Fi | TGAAATCTCA | 124 | GCCTCCCTCGC | 125 |
| | | GAGAAGTCTG | | GCCATCAGTGA | |
| | | | | AATCTCAGAGA | |
| | | | | AGTCTG | |
| | TRBV3Fo | TATGTATTGG | 126 | TATGTATTGGTA | 126 |
| | | TATAAACAGG | | TAAACAGG | |
| | TRBV3Fi | CTCTAAGAAA | 127 | GCCTCCCTCGC | 128 |
| | | TTTCTGAAGA | | GCCATCAGCTC | |
| | | | | TAAGAAATTTCT | |
| | | | | GAAGA | |
| | TRBV4Fo | GTCTTTGAAA | 129 | GTCTTTGAAAT | 129 |
| | | TGTGAACAAC | | GTGAACAAC | |
| | TRBV4Fi | GGAGCTCATG | 130 | GCCTCCCTCGC | 131 |
| | | TTTGTCTACA | | GCCATCAGGGA | |
| | | | | GCTCATGTTTG | |
| | | | | TCTACA | |
| | TRBV5Fo | GATCAAAACG | 132 | GATCAAAACGA | 132 |
| | | AGAGGACAG | | GAGGACAGC | |
| | | C | | | |
| | TRBV5aFi | CAGGGGCCC | 133 | GCCTCCCTCGC | 134 |
| | | CAGTTTATCT | | GCCATCAGCAG | |
| | | T | | GGGCCCCAGTT | |
| | | | | TATCTT | |
| | TRBV5bFi | GAAACARAGG | 135 | GCCTCCCTCGC | 136 |
| | | AAACTTCCCT | | GCCATCAGGAA | |
| | | | | ACARAGGAAAC | |
| | | | | TTCCCT | |
| | TRBV6aFo | GTGTGCCCAG | 137 | GTGTGCCCAGG | 137 |
| | | GATATGAACC | | ATATGAACC | |
| | TRBV6bFo | CAGGATATGA | 138 | CAGGATATGAG | 138 |
| | | GACATAATGC | | ACATAATGC | |
| | TRBV6aFi | GGTATCGACA | 139 | GCCTCCCTCGC | 140 |
| | | AGACCCAGG | | GCCATCAGGGT | |
| | | C | | ATCGACAAGAC | |
| | | | | CCAGGC | |
| | TRBV6bFi | TAGACAAGAT | 141 | GCCTCCCTCGC | 142 |
| | | CTAGGACTGG | | GCCATCAGTAG | |
| | | | | ACAAGATCTAG | |
| | | | | GACTGG | |
| | TRBV7Fo | CTCAGGTGTGA | 143 | CTCAGGTGTGA | 143 |
| | | ATCCAATTTC | | TCCAATTTC | |
| | TRBV7aFi | TCTAATTTACT | 144 | GCCTCCCTCGC | 145 |
| | | TCCAAGGCA | | GCCATCAGTCT | |
| | | | | AATTTACTTCCA | |
| | | | | AGGCA | |
| | TRBV7bFi | TCCCAGAGTG | 146 | GCCTCCCTCGC | 147 |
| | | ATGCTCAACG | | GCCATCAGTCC | |
| | | | | CAGAGTGATGC | |
| | | | | TCAACG | |
| | TRBV7cFi | ACTTACTTCA | 148 | GCCTCCCTCGC | 149 |
| | | ATTATGAAGC | | GCCATCAGACT | |
| | | | | TACTTCAATTAT | |
| | | | | GAAGC | |
| | TRBV7dFi | CCAGAATGAA | 150 | GCCTCCCTCGC | 151 |
| | | GCTCAACTAG | | GCCATCAGCCA | |
| | | | | GAATGAAGCTC | |
| | | | | AACTAG | |
| | TRBV9Fo | GAGACCTCTC | 152 | GAGACCTCTCT | 152 |
| | | TGTGTACTGG | | GTGTACTGG | |
| | TRBV9Fi | CTCATTCAGT | 153 | GCCTCCCTCGC | 154 |
| | | ATTATAATGG | | GCCATCAGCTC | |
| | | | | ATTCAGTATTAT | |
| | | | | AATGG | |
| | TRBV10Fo | GGAATCACCC | 155 | GGAATCACCCA | 155 |
| | | AGAGCCCAAG | | GAGCCCAAG | |
| | TRBV10Fi | GACATGGGCT | 156 | GCCTCCCTCGC | 157 |
| | | GAGGCTGATC | | GCCATCAGGAC | |
| | | | | ATGGGCTGAGG | |
| | | | | CTGATC | |
| | TRBV11Fo | CCTAAGGATC | 158 | CCTAAGGATCG | 158 |
| | | GATTTTCTGC | | ATTTTCTGC | |
| | TRBV11Fi | ACTCTCAAGA | 159 | GCCTCCCTCGC | 160 |
| | | TCCAGCCTGC | | GCCATCAGACT | |
| | | | | CTCAAGATCCA | |
| | | | | GCCTGC | |
| | TRBV12Fo | AGGTGACAGA | 161 | AGGTGACAGAG | 161 |
| | | GATGGGACAA | | ATGGGACAA | |
| | TRBV12aFi | TGCAGGGACT | 162 | GCCTCCCTCGC | 163 |
| | | GGAATTGCTG | | GCCATCAGTGC | |
| | | | | AGGGACTGGAA | |
| | | | | TTGCTG | |
| | TRBV12bFi | GTACAGACAG | 164 | GCCTCCCTCGC | 165 |
| | | ACCATGATGC | | GCCATCAGGTA | |
| | | | | CAGACAGACCA | |
| | | | | TGATGC | |
| | TRBV13Fo | CTATCCTATC | 166 | CTATCCTATCC | 166 |
| | | CCTAGACACG | | CTAGACACG | |
| | TRBV13Fi | AAGATGCAGA | 167 | GCCTCCCTCGC | 168 |
| | | GCGATAAAGG | | GCCATCAGAAG | |
| | | | | ATGCAGAGCGA | |
| | | | | TAAAGG | |
| | TRBV14Fo | AGATGTGACC | 169 | AGATGTGACCC | 169 |
| | | CAATTTCTGG | | AATTTCTGG | |
| | TRBV14Fi | AGTCTAAACA | 170 | GCCTCCCTCGC | 171 |
| | | GGATGAGTCC | | GCCATCAGAGT | |
| | | | | CTAAACAGGAT | |
| | | | | GAGTCC | |
| | TRBV15Fo | TCAGACTTTG | 172 | TCAGACTTTGA | 172 |
| | | AACCATAACG | | ACCATAACG | |
| | TRGV15Fi | AAAGATTTA | 173 | GCCTCCCTCGC | 174 |
| | | ACAATGAAGC | | GCCATCAGAAA | |
| | | | | GATTTTAACAAT | |
| | | | | GAAGC | |
| | TRBV16Fo | TATTGTGCCC | 175 | TATTGTGCCCC | 175 |
| | | CAATAAAAGG | | AATAAAAGG | |
| | TRBV16Fi | AATGTCTTTG | 176 | GCCTCCCTCGC | 177 |
| | | ATGAAACAGG | | GCCATCAGAAT | |
| | | | | GTCTTTGATGA | |
| | | | | AACAGG | |
| | TRBV17Fo | ATCCATCTTC | 178 | ATCCATCTTCT | 178 |
| | | TGGTCACATG | | GGTCACATG | |
| | TRBV17Fi | AACATTGCAG | 179 | GCCTCCCTCGC | 180 |
| | | TTGATTCAGG | | GCCATCAGAAC | |
| | | | | ATTGCAGTTGA | |
| | | | | TTCAGG | |
| | TRBV18Fo | GCAGCCCAAT | 181 | GCAGCCCAATG | 181 |
| | | GAAAGGACAC | | AAAGGACAC | |
| | TRBV18Fi | AATATCATAG | 182 | GCCTCCCTCGC | 183 |
| | | ATGAGTCAGG | | GCCATCAGAAT | |
| | | | | ATCATAGATGA | |
| | | | | GTCAGG | |
| | TRBV19Fo | TGAACAGAAT | 184 | TGAACAGAATT | 184 |
| | | TTGAACCACG | | TGAACCACG | |
| | TRBV19Fi | TTTCAGAAAG | 185 | GCCTCCCTCGC | 186 |
| | | GAGATATAGC | | GCCATCAGTTT | |
| | | | | CAGAAAGGAGA | |
| | | | | TATAGC | |
| | TRBV20Fo | TCGAGTGCCG | 187 | TCGAGTGCCGT | 187 |
| | | TTCCCTGGAC | | TCCCTGGAC | |
| | TRBV20Fi | GATGGCAACT | 188 | GCCTCCCTCGC | 189 |
| | | TCCAATGAGG | | GCCATCAGGAT | |
| | | | | GGCAACTTCCA | |
| | | | | ATGAGG | |
| | TRBV21Fo | GCAAAGATGG | 190 | GCAAAGATGGA | 190 |
| | | ATTGTGTTCC | | TTGTGTTCC | |
| | TRBV21Fi | CGCTGGAAGA | 191 | GCCTCCCTCGC | 192 |
| | | AGAGCTCAAG | | GCCATCAGCGC | |
| | | | | TGGAAGAAGAG | |
| | | | | CTCAAG | |
| | TRBV23Fo | CATTTGGTCA | 193 | CATTTGGTCAA | 193 |
| | | AAGGAAAAGG | | AGGAAAAGG | |
| | TRBV23Fi | GAATGAACAA | 194 | GCCTCCCTCGC | 195 |
| | | GTTCTTCAAG | | GCCATCAGGAA | |
| | | | | TGAACAAGTTC | |
| | | | | TTCAAG | |
| | TRBV24Fo | ATGCTGGAAT | 196 | ATGCTGGAATG | 196 |
| | | GTTCTCAGAC | | TTCTCAGAC | |
| | TRBV24Fi | GTCAAAGATA | 197 | GCCTCCCTCGC | 198 |
| | | TAAACAAAGG | | GCCATCAGGTC | |
| | | | | AAAGATATAAA | |
| | | | | CAAAGG | |
| | TRBV25Fo | CTCTGGAATG | 199 | CTCTGGAATGT | 199 |
| | | TTCTCAAACC | | TCTCAAACC | |
| | TRBV25Fi | TAATTCCACA | 200 | GCCTCCCTCGC | 201 |
| | | GAGAAGGGA | | GCCATCAGTAA | |
| | | G | | TTCCACAGAGA | |
| | | | | AGGGAG | |
| | TRBV26Fo | CCCAGAATAT | 202 | CCCAGAATATG | 202 |
| | | GAATCATGTT | | AATCATGTT | |
| | TRBV26Fi | ATTCACCTGG | 203 | GCCTCCCTCGC | 204 |
| | | CACTGGGAG | | GCCATCAGATT | |
| | | C | | CACCTGGCACT | |
| | | | | GGGAGC | |
| | TRBV27Fo | TTGTTCTCAG | 205 | TTGTTCTCAGA | 205 |
| | | AATATGAACC | | ATATGAACC | |
| | TRBV27Fi | TGAGGTGACT | 206 | GCCTCCCTCGC | 207 |
| | | GATAAGGGAG | | GCCATCAGTGA | |
| | | | | GGTGACTGATA | |
| | | | | AGGGAG | |
| | TRBV28Fo | ATGTGTCCAG | 208 | ATGTGTCCAGG | 208 |
| | | GATATGGACC | | ATATGGACC | |
| | TRBV28Fi | AAAAGGAGAT | 209 | GCCTCCCTCGC | 210 |
| | | ATTCCTGAGG | | GCCATCAGAAA | |
| | | | | AGGAGATATTC | |
| | | | | CTGAGG | |
| | TRBV29Fo | TCACCATGAT | 211 | TCACCATGATG | 211 |
| | | GTTCTGGTAC | | TTCTGGTAC | |
| | TRBV29Fi | CTGGACAGAG | 212 | GCCTCCCTCGC | 213 |
| | | CCTGACACTG | | GCCATCAGCTG | |
| | | | | GACAGAGCCTG | |
| | | | | ACACTG | |
| | TRBV30Fo | TGTGGAGGG | 214 | TGTGGAGGGAA | 214 |
| | | AACATCAAAC | | CATCAAACC | |
| | | C | | | |
| | TRBV30Fi | TTCTACTCCG | 215 | GCCTCCCTCGC | 216 |
| | | TTGGTATTGG | | GCCATCAGTTC | |
| | | | | TACTCCGTTGG | |
| | | | | TATTGG | |
| | TRBCRo | GTGTGGCCTT | 217 | GTGTGGCCTTT | 217 |
| | | TTGGGTGTGG | | TGGGTGTGG | |
| | TRBCRi | TCTGATGGCT | 218 | GCCTTGCCAGC | 219 |
| | | CAAACACAGC | | CCGCTCAGTCT | |
| | | | | GATGGCTCAAA | |
| | | | | CACAGC | |
| TRDV-C | TRDV1Fo | TGTATGAAAC | 220 | TGTATGAAACA | 220 |
| | | AAGTTGGTGG | | AGTTGGTGG | |
| | TRDV1Fi | CAGAATGCAA | 221 | GCCTCCCTCGC | 222 |
| | | AAAGTGGTCG | | GCCATCAGCAG | |
| | | | | AATGCAAAAAG | |
| | | | | TGGTCG | |
| | TRDV2Fo | ATGAAAGGAG | 223 | ATGAAAGGAGA | 223 |
| | | AAGCGATCGG | | AGCGATCGG | |
| | TRDV2Fi | TGGTTTCAAA | 224 | GCCTCCCTCGC | 225 |
| | | GACAATTTCC | | GCCATCAGTGG | |
| | | | | TTTCAAAGACA | |
| | | | | ATTTCC | |
| | TRDV3Fo | GACACTGTAT | 226 | GACACTGTATA | 226 |
| | | ATTCAAATCC | | TTCAAATCC | |
| | TRDV3Fi | GCAGATTTTA | 227 | GCCTCCCTCGC | 228 |
| | | CTCAAGGACG | | GCCATCAGGCA | |
| | | | | GATTTTACTCAA | |
| | | | | GGACG | |
| | TRDCRo | AGACAAGCGA | 229 | AGACAAGCGAC | 229 |
| | | CATTTGTTCC | | ATTTGTTCC | |
| | TRDCRi | ACGGATGGTT | 230 | GCCTTGCCAGC | 231 |
| | | TGGTATGAGG | | CCGCTCAGACG | |
| | | | | GATGGTTTGGT | |
| | | | | ATGAGG | |
| TRGV-C | TRGV1-5Fo | GGGTCATCTG | 232 | GGGTCATCTGC | 232 |
| | | CTGAAATCAC | | TGAAATCAC | |
| | TRGV1- | AGGAGGGGA | 233 | GCCTCCCTCGC | 234 |
| | 5,8Fi | AGGCGCCACA | | GCCATCAGAGG | |
| | | G | | AGGGGAAGGC | |
| | | | | CCCACAG | |
| | TRGV8Fo | GGGTCATCAG | 235 | GGGTCATCAGC | 235 |
| | | CTGTAATCAC | | TGTAATCAC | |
| | TRGV5pFi | AGGAGGGGA | 236 | GCCTCCCTCGC | 237 |
| | | AGACCCCACA | | GCCATCAGAGG | |
| | | G | | AGGGGAAGACC | |
| | | | | CCACAG | |
| | TRGV9Fo | AGCCCCGCCT | 238 | AGCCCGCCTGG | 238 |
| | | GGAATGTGTG | | AATGTGTGG | |
| | | G | | | |
| | TRGV9Fi | GCACTGTCAG | 239 | GCCTCCCTCGC | 240 |
| | | AAAGGAATCC | | GCCATCAGGCA | |
| | | | | CTGTCAGAAAG | |
| | | GAATCC | | | |
| | TRGV10Fo | AAGAAAAGTA | 241 | AAGAAAAGTAT | 241 |
| | | TTGACATACC | | TGACATACC | |
| | TRGV10Fi | ATATTGTCTC | 242 | GCCTCCCTCGC | 243 |
| | | AACAAAATCC | | GCCATCAGATA | |
| | | | | TTGTCTCAACA | |
| | | | | AAATCC | |
| | TRGV11Fo | AGAGTGCCCA | 244 | AGAGTGCCCAC | 244 |
| | | CATATCTTGG | | ATATCTTGG | |
| | TRGV11Fi | GCTCAAGATT | 245 | GCCTCCCTCGC | 246 |
| | | GCTCAGGTG | | GCCATCAGGCT | |
| | | G | | CAAGATTGCTC | |
| | | | | AGGTGG | |
| | TRGCRo | GGATCCCAGA | 247 | GGATCCCAGAA | 247 |
| | | ATCGTGTTGC | | TCGTGTTGC | |
| | TRGCRi | GGTATGTTCC | 248 | GCCTTGCCAGC | 249 |
| | | AGCCTTCTGG | | CCGCTCAGGGT | |
| | | | | ATGTTCCAGCC | |
| | | | | TTCTGG | |

TABLE 2

| | Primer | | SEQ ID | | SEQ ID |
|---|---|---|---|---|---|
| Locus | Name | Sequence | NO. | Ordered | NO. |
| IgHV-J | IgHV1aFo | AGTGAAGGTCTC | 250 | AGTGAAGGTCTC | 250 |
| | | CTGCAAGG | | CTGGAAGG | |
| | IgHV1bFo | AGTGAAGGTTTC | 251 | AGTGAAGGTTTC | 251 |
| | | CTGCAAGG | | CTGCAAGG | |
| | IgHV1aFi | AGTTCCAGGGCA | 252 | GCCTCCCTCGCG | 253 |
| | | GAGTCAC | | CCATCAGAGTTC | |
| | | | | CAGGGCAGAGTC | |
| | | | | AC | |
| | IgHV1bFi | AGTTTCAGGGCA | 254 | GCCTCCCTCGCG | 255 |
| | | GGGTCAC | | CCATCAGAGTTT | |
| | | | | CAGGGCAGGGTC | |
| | | | | AC | |
| | IgHV1cFi | AGTTCCAGGAAA | 256 | GCCTCCCTCGCG | 257 |
| | | GAGTCAC | | CCATCAGAGTTC | |
| | | | | CAGGAAAGAGTC | |
| | | | | AC | |
| | IgHV1dFi | AATTCCAGGACA | 258 | GCCTCCCTCGCG | 259 |
| | | GAGTCAC | | CCATCAGAATTC | |
| | | | | CAGGACAGAGTC | |
| | | | | AC | |
| | IgHV2Fo | TCTCTGGGTTCT | 260 | TCTCTGGGTTCT | 260 |
| | | CACTCAGC | | CACTCAGC | |
| | IgHV2Fi | AAGGCCCTGGAG | 261 | GCCTCCCTCGCG | 262 |
| | | TGGCTTGC | | CCATCAGAAGGC | |
| | | | | CCTGGAGTGGCT | |
| | | | | TGC | |
| | IgHV3aFo | TCCCTGAGACTC | 263 | TCCCTGAGACTC | 263 |
| | | TCCTGTGC | | TCCTGTGC | |
| | IgHV3bFo | CTCTCCTGTGCA | 264 | CTCTCCTGTGCA | 264 |
| | | GCCTCTGG | | GCCTCTGG | |
| | IgHV3cFo | GGTCCCTGAGAC | 265 | GGTCCCTGAGAC | 265 |
| | | TCTCCTGT | | TCTCCTGT | |
| | IgHV3dFo | CTGAGACTCTCC | 266 | CTGAGACTCTCC | 266 |
| | | TGTGTAGC | | TGTGTAGC | |
| | IgHV3aFi | CTCCAGGGAAGG | 267 | GCCTCCCTCGCG | 268 |
| | | GGCTGG | | CCATCAGCTCCA | |
| | | | | GGGAAGGGGCT | |
| | | | | GG | |
| | IgHV3bFi | GGCTCCAGGCAA | 269 | GCCTCCCTCGCG | 270 |
| | | GGGGCT | | CCATCAGGGCTC | |
| | | | | CAGGCAAGGGGC | |
| | | | | T | |
| | IgHV3cFi | ACTGGGTCCGCC | 271 | GCCTCCCTCGCG | 272 |
| | | AGGCTCC | | CCATCAGACTGG | |
| | | | | GTCCGCCAGGCT | |
| | | | | CC | |
| | IgHV3dFi | GAAGGGGCTGGA | 273 | GCCTCCCTCGCG | 274 |
| | | GTGGGT | | CCATCAGGAAGG | |
| | | | | GGCTGGAGTGGG | |
| | | | | T | |
| | IgHV3eFi | AAAAGGTCTGGA | 275 | GCCTCCCTCGCG | 276 |
| | | GTGGGT | | CCATCAGAAAAG | |
| | | | | GTCTGGAGTGGG | |
| | | | | T | |
| | IgHV4Fo | AGAGCCTGTCCC | 277 | AGACCCTGTCCC | 277 |
| | | TCACCTGC | | TCACCTGC | |
| | IgHV4Fi | AGGGVCTGGAGT | 278 | GCCTCCGTCGCG | 279 |
| | | GGATTGGG | | CCATCAGAGGGV | |
| | | | | CTGGAGTGGATT | |
| | | | | GGG | |
| | IgHV5Fo | GCGCCAGATGCC | 280 | GCGCCAGATGCC | 280 |
| | | CGGGAAAG | | CGGGAAAG | |
| | IgHV5i | GGCCASGTCACC | 281 | GCCTCCCTCGCG | 282 |
| | | ATCTCAGC | | CCATCAGGGCCA | |
| | | | | SGTCACCATCTC | |
| | | | | AGC | |
| | IgHV6Fo | CCGGGGACAGTG | 283 | CCGGGGACAGTG | 283 |
| | | TCTCTAGC | | TCTCTAGC | |
| | IgHV6Fi | GCCTTGAGTGGC | 284 | GCCTCCCTCGCG | 285 |
| | | TGGGAAGG | | CCATCAGGCCTT | |
| | | | | GAGTGGCTGGGA | |
| | | | | AGG | |
| | IgHV7Fo | GTTTCCTGCAAG | 286 | GTTTCCTGCAAG | 286 |
| | | GCTTCTGG | | GCTTCTGG | |
| | IgHV7Fi | GGCTTGAGTGGA | 287 | GCCTCCCTCGCG | 288 |
| | | TGGGATGG | | CCATCAGGGCTT | |
| | | | | GAGTGGATGGGA | |
| | | | | TGG | |
| | IgHJRo | ACCTGAGGAGAC | 289 | ACCTGAGGAGAC | 289 |
| | | GGTGACC | | GGTGACC | |
| | IgHJ1Ri | CAGTGCTGGAAG | 290 | GCCTTGCCAGCC | 291 |
| | | TATTCAGC | | CGCTCAGCAGTG | |
| | | | | CTGGAAGTATTC | |
| | | | | AGC | |
| | IgHJ2Ri | AGAGATCGAAGT | 292 | GCCTTGCCAGCC | 293 |
| | | ACCAGTAG | | CGCTCAGAGAGA | |
| | | | | TCGAAGTACCAG | |
| | | | | TAG | |
| | IgHJ3Ri | CCCCAGATATCA | 294 | GCCTTGCCAGCC | 295 |
| | | AAAGCATC | | CGCTCAGCCCCA | |
| | | | | GATATCAAAAGC | |
| | | | | ATC | |
| | IgHJ4Ri | GGCCCCAGTAGT | 296 | GCCTTGCCAGCC | 297 |
| | | CAAAGTAG | | CGCTCAGGGCCC | |
| | | | | CAGTAGTCAAAG | |
| | | | | TAG | |
| | IgHJ5Ri | CCCAGGGGTCGA | 298 | GCCTTGCCAGCC | 299 |
| | | ACCAGTTG | | CGCTCAGCCCAG | |
| | | | | GGGTCGAACCAG | |
| | | | | TTG | |
| | IgHJ6Ri | CCCAGACGTCCA | 300 | GCCTTGCCAGCC | 301 |
| | | TGTAGTAG | | CGCTCAGCCCAG | |
| | | | | ACGTCCATGTAG | |
| | | | | TAG | |
| IgKV-C | IgKV1Fo | TAGGAGACAGAG | 302 | TAGGAGACAGAG | 302 |
| | | TCACCATC | | TCACCATC | |
| | IgKV1Fi | TTCAGYGRCAGT | 303 | GCCTCCCTCGCG | 304 |
| | | GGATCTGG | | CCATCAGTTCAG | |
| | | | | YGRCAGTGGATC | |
| | | | | TGG | |
| | IgKV2Fo | GGAGAGCCGOC | 305 | GGAGAGCCOGC | 305 |
| | | CTCCATCTC | | CTCCATCTC | |
| | IgKV2aFi | TGGTACCTGCAG | 306 | GCCTCCCTCGCG | 307 |
| | | AAGCCAGG | | CCATCAGTGGTA | |
| | | | | CCTGCAGAAGCG | |
| | | | | AGG | |
| | IgKV2bFi | CTTCAGCAGAGG | 308 | GCCTCCCTCGCG | 309 |
| | | CCAGGCCA | | CCATCAGCTTCA | |
| | | | | GCAGAGGCCAGG | |
| | | | | CCA | |
| | IgKV3-7Fo | GCCTGGTACCAG | 310 | GCCTGGTACCAG | 310 |
| | | CAGAAACC | | CAGAAACC | |
| | IgKV3Fi | GCCAGGTTCAGT | 311 | GCCTCCCTCGCG | 312 |
| | | GGCAGTGG | | CCATCAGGCCAG | |
| | | | | GTTCAGTGGCAG | |
| | | | | TGG | |
| | IgKV6-7Fi | TCGAGGTTCAGT | 313 | GCCTCCCTCGCG | 314 |
| | | GGCAGTGG | | CCATCAGTCGAG | |
| | | | | GTTCAGTGGCAG | |
| | | | | TGG | |
| | IgKV4-5Fi | GACCGATTCAGT | 315 | GCCTCCCTCGCG | 316 |
| | | GGCAGCGG | | CCATCAGGACCG | |
| | | | | ATTCAGTGGCAG | |
| | | | | CGG | |
| | IgKCRo | TTCAACTGCTCAT | 317 | TTCAACTGCTCAT | 317 |
| | | CAGATGG | | CAGATGG | |
| | IgKCRi | ATGAAGACAGAT | 318 | GCCTTGCCAGCC | 319 |
| | | GGTGCAGC | | CGCTCAGATGAA | |
| | | | | GACAGATGGTGC | |
| | | | | AGC | |
| IgLV-C | IgLV1aFo | GGGCAGAGGGTC | 320 | GGGCAGAGGGTC | 320 |
| | | ACCATCTC | | ACCATCTC | |
| | IgLV1bFo | GGACAGAAGGTC | 321 | GGACAGAAGGTC | 321 |
| | | ACCATCTC | | ACCATCTC | |
| | IgLV1aFi | TGGTAGGAGCAG | 322 | GCCTCCCTCGCG | 323 |
| | | CTCCCAGG | | CCATCAGTGGTA | |
| | | | | CCAGCAGCTCCC | |
| | | | | AGG | |
| | IgLV1bFi | TGGTACCAGCAG | 324 | GCCTCCCTCGCG | 325 |
| | | CTTCCAGG | | CCATCAGTGGTA | |
| | | | | CCAGCAGCTTCC | |
| | | | | AGG | |
| | IgLV2Fo | CTGCACTGGAAC | 326 | CTGCACTGGAAG | 326 |
| | | CAGCAGTG | | CAGCAGTG | |
| | IgLV2Fi | TCTCTGGCTCCA | 327 | GCCTCCCTCGCG | 328 |
| | | AGTCTGGC | | CCATCAGTCTCT | |
| | | | | GGCTCCAAGTCT | |
| | | | | GGC | |
| | IgLV3aFo | ACCAGCAGAAGC | 329 | ACCAGCAGAAGC | 329 |
| | | CAGGCCAG | | CAGGCCAG | |
| | IgLV3bFo | GAAGCAGGACA | 330 | GAAGCCAGGACA | 330 |
| | | GGCCCCTG | | GGCCCCTG | |
| | IgLV3aFi | CTGAGCGATTCT | 331 | GCCTCCCTCGCG | 332 |
| | | CTGGCTCC | | CCATCAGCTGAG | |
| | | | | CGATTCTCTGGC | |
| | | | | TCC | |
| | IgLV3bFi | TTCTCTGGGTCC | 333 | GCCTCCCTCGCG | 334 |
| | | ACCTCAGG | | CCATCAGTTCTCT | |
| | | | | GGGTCCACCTCA | |
| | | | | GG | |
| | IgLV3cFi | TTCTCTGGCTCC | 335 | GCCTCCCTCGCG | 336 |
| | | AGCTCAGG | | CCATCAGTTCTCT | |
| | | | | GGCTCCAGCTCA | |
| | | | | GG | |
| | IgLV4Fo | TCGGTCAAGCTC | 337 | TCGGTCAAGCTC | 337 |
| | | ACCTGCAC | | ACCTGCAC | |
| | IgLV4Fi | GGGCTGACCGCT | 358 | GCCTCCCTCGCG | 338 |
| | | ACCTCACC | | CCATCAGGGGCT | |
| | | | | GACCGCTACCTC | |
| | | | | ACC | |
| | IgLV5Fo | CAGCCTGTGCTG | 339 | CAGCCTGTGCTG | 339 |
| | | ACTCAGCC | | ACTCAGCC | |
| | IgLV5Fi | CCAGCCGCTTCT | 340 | GCCTCCCTCGCG | 341 |
| | | CTGGATCC | | CCATCAGCCAGC | |
| | | | | CGCTTCTCGGA | |
| | | | | TCCV | |
| | IgLV6Fo | CCATCTCTGCA | 342 | CCATCTCCTGCA | 342 |
| | | CCCGCAGC | | CCCGCAGC | |
| | IgLV7-8Fo | TCCCCWGGAGG | 343 | TCCCCWGGAGG | 343 |
| | | GACAGTCAC | | GACAGTCAC | |
| | IgLV9,11Fo | CTCMCCTGCACC | 344 | CTCMCCTGCACC | 344 |
| | | CTGAGCAG | | CTGAGCAG | |
| | IgLV10Fo | AGACCGCCACAC | 345 | AGACCGCCACAC | 345 |
| | | TCACCTGC | | TCACCTGC | |
| | IgLV6,8Fi | CTGATCGSTTCTC | 346 | GCCTCCCTCGCG | 347 |
| | | TGGCTCC | | CCATCAGCTGAT | |
| | | | | CGSTTCTCTGGC | |
| | | | | TCC | |
| | IgLV7Fi | CTGCCCGGTTCT | 348 | CTGCCCGGTTCT | 348 |
| | | CAGGCTCC | | CAGGCTCC | |
| | IgLV9Fi | ATCCAGGAAGAG | 349 | GCCTCCCTCGCG | 359 |
| | | GATGAGAG | | CCATCAGATCCA | |
| | | | | GGAAGAGGATGA | |
| | | | | GAG | |
| | IgLV10-11Fi | CTCCAGCCTGAG | 351 | GCCTCCCTCGCG | 352 |
| | | GACGAGGC | | CCATCAGGTCCA | |
| | | | | GCCTGAGGACGA | |
| | | | | GGC | |
| | IgLC1-7Ro | GCTCCCGGGTAG | 353 | GCTCCCGGGTAG | 353 |
| | | AAGTCACT | | AAGTCACT | |
| | IgLC1-7Ri | AGTGTGGCCTTG | 354 | GCCTTGCCAGCC | 355 |
| | | TTGGCTTG | | CGCTCAGAGTGT | |
| | | | | GGCCTTGTTGGC | |
| | | | | TTG | |
| | 454A | GCCTCCCTCGCG | 356 | GCCTCCCTCGCG | 356 |
| | | CCATCAG | | CCATCAG | |
| | 454B | GCCTTGCCAGGC | 351 | GCCTTGCCAGCC | 351 |
| | | CGCTCAG | | CGCTCAG | |

Now, therefore, the following is claimed:

1. A method for evaluating changes in immune response cell populations and associating those changes with a specific disease, the method comprising the steps of:
(a) isolating a subpopulation of white blood cells from at least one human or animal subject;
(b) isolating RNA from the subpopulation of cells;
(c) amplifying the RNA using RT-PCR in a first amplification reaction to produce amplicons using nested primers, at least a portion of the nested primers comprising additional nucleotides to incorporate into a resulting amplicon a binding site for a communal primer;
(d) separating the amplicons from the first amplification reaction from one or more unused primers from the first amplification reaction;
(e) amplifying, by the addition of communal primers in a second amplification reaction, the amplicons of the first amplification reaction having at least one binding site for a communal primer; and
(f) sequencing the amplicons of the second amplification reaction to identify antibody and/or receptor rearrangements in the subpopulation of cells.

2. The method of claim 1, wherein the product of the second amplification reaction is a polynucleotide comprising the complementarity determining region 3 (CDR3).

3. The method of claim 1, wherein the step of isolating a subpopulation of white blood cells is performed by flow cytometry.

4. The method of claim 1, wherein the subpopulation of white blood cells comprises T cells.

5. The method of claim 4, wherein the T cells are selected from the group consisting of naïve T cells, mature T cells and memory T cells.

6. The method of claim 1, wherein the subpopulation of white blood cells comprises B cells.

7. The method of claim 6, wherein the B cells are selected from the group consisting of naïve B cells, mature B cells and memory B cells.

8. The method of claim 1, wherein the rearrangements in the subpopulations of cells are selected from the group consisting of rearrangements of B-cell immunoglobulin heavy chain (IgH), B-cell kappa, B-cell lambda light chains, T-cell receptor Beta, T-cell Gamma and T-cell Delta.

9. The method of claim 1, further comprising the steps of:
(g) comparing the rearrangements identified for a population of individuals to whom a vaccine has been administered with the rearrangements identified for a population of individuals to whom the vaccine was not administered; and
(h) evaluating the efficacy of the vaccine in producing an immune response.

10. The method of claim 1, further comprising the steps of:
(g) comparing the rearrangements identified for a population of normal individuals with the rearrangements identified for a population of individuals who have been diagnosed with a disease;
(h) determining if there is a correlation between a specific rearrangement or set of rearrangements and the disease.

11. A method for analyzing semi-quantitative sequence information to provide one or more immune status reports for a human or animal, the method comprising the steps of:
(a) identifying one or more distinct CDR3 sequences that are shared between a subject's immunoprofile and a cumulative immunoprofile from a disease library stored in a database;
(b) summing a total number of a subject's detected sequences corresponding to those shared distinct CDR3 sequences;
(c) computing the percentage of the total number of detected sequences in the subject's immunoprofile that are representative of those distinct CDR3s shared between the subject's immunoprofile and the disease library to create one or more original sharing indices;
(d) randomly selecting sequences from a public library stored in a database to form a sub-library, the sub-library comprising a number of distinct CDR3 sequences that is approximately equal to the number of distinct CDR3 sequences in the disease library;
(e) identifying one or more distinct CDR3 sequences that are shared between the subject's immunoprofile and the sub-library;
(f) summing a total number of detected sequences corresponding to those shared CDR3 sequences and calculating a percentage of the total number of detected sequences in the subject's immunoprofile that are shared between the subject's immunoprofile and the sub-library to create a sampling sharing index;
(g) repeating steps (d)-(f) at least 1000 or more times; and
(h) estimating the P-value as the fraction of times the sampling sharing indices are greater than or equal to the original sharing index between a patient's immunoprofile and a disease library.

12. A method for developing a database of personal immunorepertoires, the method comprising the steps of:
(a) amplifying and sequencing one or more RNAs from a subpopulation of white blood cells from one or more individuals;
(b) inputting the sequences into a database to provide data which may be stored on a computer, server, or other electronic storage device;
(c) inputting identifying information and characteristics for an individual corresponding to the sequences of the one or more RNAs as data which may also be stored on a computer, server, or other electronic storage device, and
(d) evaluating the data of step (b) and step (a) for one or more individuals to determine whether a correlation exists between the one or more RNA sequences and one or more characteristics of the individual corresponding to the sequence(s).

13. The method of claim 12, wherein the identifying information is selected from the group consisting of a patient identification number, a code comprising the patient's HLA type, a disease code comprising one or more clinical diagnoses that may have been made, a “staging code” comprising the date of the sample, a cell type code comprising the type of cell subpopulation from which the RNA was amplified and sequenced, and one or more sequence codes comprising the sequences identified for the sample.

14. The method of claim 12, wherein the subpopulation of white blood cells comprises T cells.

15. The method of claim 14, wherein the T cells are selected from the group consisting of naïve T cells, mature T cells and memory T cells.

16. The method of claim 12, wherein the subpopulation of white blood cells comprises B cells.

17. The method of claim 16, wherein the B cells are selected from the group consisting of naïve B cells, mature B cells and memory B cells.
